(19) United States
(12) Patent Application Publication
(10) Pub. No.: US 2024/0006715 A1
(43) Pub. Date: Jan. 4, 2024

(54) SOLID ELECTROLYTE LAMINATED SHEET, ALL-SOLID STATE SECONDARY BATTERY, AND MANUFACTURING METHOD FOR ALL-SOLID STATE SECONDARY BATTERY

(71) Applicant: FUJIFILM Corporation, Tokyo (JP)

(72) Inventor: Hideyuki SUZUKI, Kanagawa (JP)

(73) Assignee: FUJIFILM Corporation, Tokyo (JP)

(21) Appl. No.: 18/361,903

(22) Filed: Jul. 30, 2023

Related U.S. Application Data
(63) Continuation of application No. PCT/JP2022/013526, filed on Mar. 23, 2022.

(30) Foreign Application Priority Data
Mar. 26, 2021 (JP) 2021-053904

(51) Int. Cl. H01M 50/431; H01M 10/0525; H01M 50/497; H01M 50/491; H01M 4/38; H01M 50/403; H01M 10/058

(52) U.S. Cl. CPC H01M 50/431; H01M 10/0525; H01M 50/497; H01M 50/491; H01M 4/382; H01M 50/403; H01M 10/058; H01M 2004/027

(57) ABSTRACT

There is provided a solid electrolyte laminated sheet including a sheet-shaped porous support internally containing an inorganic solid electrolyte and a solid electrolyte layer internally containing an inorganic solid electrolyte, in which a void ratio of the porous support is 20% or more, and a void ratio of the solid electrolyte layer is smaller than the void ratio of the porous support. There are also provided a manufacturing method for an all-solid state secondary battery in which this solid electrolyte laminated sheet is used to carry out pressurization and manufacturing while adjusting void ratio of the porous support and the solid electrolyte layer, and an all-solid state secondary battery.

### CROSS-REFERENCE TO RELATED APPLICATIONS

This application is a Continuation of PCT International Application No. PCT/JP2022/013526 filed on Mar. 23, 2022, which claims priority under 35 U.S.C. § 119 (a) to Japanese Patent Application No. 2021-053904 filed in Japan on Mar. 26, 2021. Each of the above applications is hereby expressly incorporated by reference, in its entirety, into the present application.

### BACKGROUND OF THE INVENTION

### 1. Field of the Invention

The present invention relates to a solid electrolyte laminated sheet, an all-solid state secondary battery, and a manufacturing method for an all-solid state secondary battery.

### 2. Description of the Related Art

A secondary battery, such as a lithium ion secondary battery, is a storage battery that has a negative electrode, a positive electrode, and an electrolyte sandwiched between the negative electrode and the positive electrode, and generally enables charging and discharging by reciprocal migration of ions of a metal belonging to Group 1 or Group 2 of the periodic table (hereinafter, may be simply referred to as a metal) between both electrodes. In the related art, in a secondary battery, an organic electrolytic solution has been used as the electrolyte. However, the organic electrolytic solution is likely to leak, and a short circuit may occur in the battery due to overcharging or overdischarging. Therefore, further improvement in safety and reliability is required.

Under such circumstances, an all-solid state secondary battery using an incombustible inorganic solid electrolyte instead of an organic electrolytic solution is being developed. All of the negative electrode, the electrolyte, and the positive electrode of the all-solid state secondary battery consist of a solid, and thus safety or reliability that is a problem of a battery formed of an organic electrolytic solution can be greatly improved, which makes it possible to achieve a longer life.

In a secondary battery, during charging, electrons migrate from the positive electrode to the negative electrode, at the same time, metal ions are deintercalated from the active material that constitutes the positive electrode, and these metal ions reach the negative electrode through the electrolyte and are accumulated in the negative electrode. As described above, there is a phenomenon in which some of the metal ions accumulated in the negative electrode capture electrons and are precipitated as the metal. In a case where this metal precipitate grows in a dendrite shape due to repeated charging and discharging, the metal precipitate eventually reaches the positive electrode. As a result, an internal short circuit occurs, so that a function as a secondary battery is lost. In particular, in a lithium ion secondary battery in which reciprocal migration of lithium ions occurs, the generation and growth of dendrites of metallic lithium are remarkable, and an internal short circuit is likely to occur. As a result, in the all-solid state secondary battery as well, it is also important to block the arrival of dendrites consisting of a metal (simply, referred to as dendrites) at the positive electrode, in terms of extending the life of a battery.

In order to cope with the problem of the internal short circuit due to dendrites, a technique of forming a solid electrolyte layer having a multilayer structure, which constitutes an all-solid state secondary battery, has been proposed.

For example, JP2020-107594A discloses “a solid electrolyte layer obtained by laminating an inorganic solid electrolyte layer containing particles of an inorganic solid electrolyte and having a void ratio of 10% or less, and an easy-destruction layer containing particles of an inorganic solid electrolyte and having a void ratio of 15% or less” and an all-solid state secondary battery including this solid electrolyte laminated sheet.

WO2020-196040A discloses a laminated sheet for a negative electrode, which has “an electron-ion conductive layer containing a lithium ion conductive inorganic solid electrolyte and electron conductive particles, being adjacent to a negative electrode collector, and having a void ratio of 20% or more, and has an ion conductive layer containing a lithium ion conductive inorganic solid electrolyte, being provided on a side of the electron-ion conductive layer opposite to the negative electrode collector, and having a void ratio of 20% or more”. In addition, WO2020-196040A discloses an all-solid state lithium ion secondary battery using this laminated sheet for a negative electrode, where the all-solid state secondary battery has a laminated sheet for a negative electrode, which has “an electron-ion conductive layer containing a lithium ion conductive inorganic solid electrolyte and electron conductive particles, being adjacent to a negative electrode collector, and having a void ratio of 15% or more, has an ion conductive layer containing a lithium ion conductive inorganic solid electrolyte, being provided on a side of the electron-ion conductive layer opposite to the negative electrode collector, and having a void ratio of 10% or less, and has a positive electrode active material layer adjacent to a side of the ion conductive layer opposite to the ion conductive layer, in which in a charged state, at least the electron-ion conductive layer has a negative electrode active material, and the negative electrode active material is metallic lithium”.

Further, JP2016-058250A discloses a lithium battery that uses, as a negative electrode, an electrode body for a lithium battery, which has, in the following order; a collector electrode, a negative electrode active material, a wet sandy electrolyte layer impregnated with a normal temperature molten salt electrolyte of a plurality of particles, and an inorganic solid electrolyte layer.

### SUMMARY OF THE INVENTION

In general, in a case where an all-solid state secondary battery is charged, the precipitation and dissolution of the metal are repeated due to charging and discharging, and the negative electrode active material layer undergoes volume change (expansion and contraction). In particular, an all-solid state secondary battery in a form in which a metal obtained by reducing and precipitating, on the negative electrode side, metal ions generated in the positive electrode active material layer due to charging is used as the negative electrode active material layer undergoes a large volume change since the precipitation and dissolution of the metal occur between the between the negative electrode collector and the solid electrolyte layer, which are disposed adjacent to each other. Voids are gradually formed in the layers or between the layers due to this volume change, and in these voids, the metal cannot be dissolved (ionized) in a case where the metal is isolated and contactless with respect to the negative electrode collector or the solid electrolyte layer (the formation of the isolated metal). It is conceived that such generation of the isolated metal causes a gradual decrease in the discharge capacity (the amount of the metal that can be ionized gradually decreases), the cycle characteristics deteriorate, which consequently makes the discharging impossible.

Moreover, in a case where the voids are formed, the growth of the dendrite that proceeds along the grain boundary is accelerated, which also promotes the occurrence of the internal short circuit.

JP2016-058250A has not sufficiently studied the prevention of the occurrence of such an internal short circuit and the suppression of the deterioration of cycle characteristics. On the other hand, according to the techniques described in Patent JP2020-107594A and WO2020-196040A, it is expected that the occurrence of the internal short circuit and the deterioration of the cycle characteristics can be suppressed to some extent in the all-solid state secondary battery. However, in recent years, the development for practical use of an all-solid state secondary battery has been rapidly proceeding, and it is desired to suppress the occurrence of the internal short circuit at a high level and realize high reliability (safety) in addition to further improvement of the battery performance such as cycle characteristics.

An object of the present invention is to provide a solid electrolyte laminated sheet to be incorporated into an all-solid state secondary battery, which realizes the further improvement of cycle characteristics as well while suppressing the occurrence of the internal short circuit in the all-solid state secondary battery even in a case where an all-solid state secondary battery is repeatedly charged and discharged. In addition, another object of the present invention is to provide an all-solid state secondary battery in which the occurrence of the internal short circuit is suppressed and which is excellent in cycle characteristics, and a manufacturing method for the all-solid state secondary battery.

As a result of various studies, the inventors of the present invention got an idea that in a case where a solid electrolyte layer to be incorporated into an all-solid state secondary battery has a multilayer structure, and further, one of the layers thereof is constituted with a layer that enables the precipitation of the metal without a large volume change, and another layer thereof is constituted with a dense layer having few voids, the occurrence of the internal short circuit can be suppressed, and moreover, the deterioration of cycle characteristics can also be suppressed.

As a result of further detailed studies based on this idea, the inventors of the present invention found that in an all-solid state secondary battery, in a case where a layer that enables the precipitation of the metal is constituted with a layer in which not only a large number of voids accommodating the metal to be precipitated are simply provided (the void ratio is simply increased) but also defects (cracking, breakage, destruction, and the like) due to the precipitation and dissolution of the metal are unlikely to occur even in a case where the void ratio is increased by incorporating a support that serves as a basic skeleton, it is possible to accommodate the precipitated metal without being isolated during dissolution, while suppressing the volume change due to the precipitation and dissolution of the metal. In addition, it was found that in a case of disposing this layer and the dense layer to be superimposed, it is possible to block propagation of a stress to the dense layer caused by the volume change due to the precipitation and dissolution of the metal, thereby blocking the generation of defects in the dense layer, and as a result, it is possible to effectively inhibit the penetration of dendrite into the positive electrode.

Further, in a case of manufacturing the above-described all-solid state secondary battery, it was found that in a case of using a laminated sheet internally containing an inorganic solid electrolyte, which is obtained by laminating a porous support having a predetermined void ratio and a solid electrolyte layer having a void ratio smaller than that of this porous support and pressurizing this laminated sheet, it is possible to form the layer that enables the precipitation of the metal and the dense layer, which are described above.

The present invention has been completed through further studies based on these findings.

That is, the above problems have been solved by the following means.
<1> A solid electrolyte laminated sheet comprising:
a sheet-shaped porous support which internally contains an inorganic solid electrolyte having ion conductivity of a metal belonging to Group 1 or Group 2 in the periodic table;
a solid electrolyte layer on one surface of this porous support, which contains an inorganic solid electrolyte having ion conductivity of a metal belonging to Group 1 or Group 2 in the periodic table;
wherein a void ratio of the porous support is 20% or more, and a void ratio of the solid electrolyte layer is smaller than the void ratio of the porous support.
<2> The solid electrolyte laminated sheet according to <1>, in which the inorganic solid electrolyte which is internally contained in the porous support is particles smaller than an opening diameter of the porous support.
<3> The solid electrolyte laminated sheet according to <1> or <2>, in which the inorganic solid electrolyte which is contained in the solid electrolyte layer contains particles larger than and particles smaller than an opening diameter of the porous support.
<4> The solid electrolyte laminated sheet according to any one of <1> to <3>, further comprising a negative electrode collector on the other surface of the porous support.
<5> An all-solid state secondary battery formed of the solid electrolyte laminated sheet according to any one of <1> to <4>,
in which the all-solid state secondary battery has a layer structure in which a negative electrode collector, the porous support of the solid electrolyte laminated sheet, the solid electrolyte layer, and the positive electrode active material layer are laminated and pressure-bonded in this order,
a void ratio of the porous support after the lamination and the pressure bonding is 15% or more, and
a void ratio of the solid electrolyte layer after the lamination and the pressure bonding is 10% or less.
<6> The all-solid state secondary battery according to <5>, in which the all-solid state secondary battery has a negative electrode active material layer between the negative electrode collector and the porous support.
<7> The all-solid state secondary battery according to <6>, in which the negative electrode active material layer is a metallic lithium foil.
<8> The all-solid state secondary battery according to <5>, in which in a charged state of the all-solid state secondary battery, at least the porous support internally contains a negative electrode active material.
<9> The all-solid state secondary battery according to any one of <5> to <8>, in which the inorganic solid electrolyte which is internally contained in the porous support after the lamination and the pressure bonding is particles smaller than an opening diameter of the porous support.
<10> The all-solid state secondary battery according to any one of <5> to <9>, in which the inorganic solid electrolyte which is contained in the solid electrolyte layer after the lamination and the pressure bonding contains particles larger than and particles smaller than an opening diameter of the porous support.
<11> A manufacturing method for an all-solid state secondary battery, which is a manufacturing method for an all-solid state secondary battery by using the solid electrolyte laminated sheet according to any one of <1> to <4>, the manufacturing method comprising:
a step of pressurizing the solid electrolyte laminated sheet until the solid electrolyte layer has a void ratio of 10% or less while suppressing a void ratio of the porous support of the solid electrolyte laminated sheet to 15% or more.
<12> The manufacturing method for an all-solid state secondary battery according to <11>, further comprising a step of forming a negative electrode active material layer between the negative electrode collector and the porous support.
<13> The manufacturing method for an all-solid state secondary battery according to <12>, in which the step of forming the negative electrode active material layer is a step of forming a film of a negative electrode composition containing a negative electrode active material or a step of laminating a metallic lithium foil.
<14> The manufacturing method for an all-solid state secondary battery according to <12>, in which the step of forming the negative electrode active material layer is a step of charging an all-solid state secondary battery to precipitate a negative electrode active material at least in the porous support, after the step of the pressurizing.

In the all-solid state secondary battery according to the aspect of the present invention, the occurrence of the internal short circuit is suppressed, and the cycle characteristics are also excellent. In addition, the manufacturing method for an all-solid state secondary battery according to the aspect of the present invention makes it possible to simply manufacture an all-solid state secondary battery in which the occurrence of the internal short circuit is suppressed, and the cycle characteristics also excellent. Further, in a case of being used in the manufacture of an all-solid state secondary battery, the solid electrolyte laminated sheet according to the aspect of the present invention makes it possible to realize the above-described all-solid state secondary battery having excellent characteristics.

The above-described and other characteristics and advantages of the present invention will be further clarified by the following description with appropriate reference to the accompanying drawing.

### BRIEF DESCRIPTION OF THE DRAWINGS

FIG. 1 is a longitudinal cross-sectional view schematically showing a preferred embodiment of an all-solid state secondary battery according to the present invention.

FIG. 2 is a longitudinal cross-sectional view schematically showing a preferred embodiment of a solid electrolyte laminated sheet according to the present invention.

### DESCRIPTION OF THE PREFERRED EMBODIMENTS

In the description of the present invention, a numerical value range indicated using “to” means a range including numerical values before and after the “to” as the lower limit value and the upper limit value. In a case where a plurality of numerical value range values are set and described for the content, physical properties, and the like of a component in the present invention, the upper limit value and the lower limit value, which form the numerical value range are not limited to a specific combination of the upper limit value and the lower limit value and can be set to a numerical value range obtained by appropriately combining the upper limit value and the lower limit value of each numerical value range.

[All-Solid State Secondary Battery]

First, a preferred embodiment of an all-solid state secondary battery according to the embodiment of the present invention will be described with reference to the drawings.

The all-solid state secondary battery according to the embodiment of the present invention is an all-solid state secondary battery manufactured by using the solid electrolyte laminated sheet according to the embodiment of the present invention, and has a layer structure in which a negative electrode collector, a porous support of the solid electrolyte laminated sheet, a solid electrolyte layer of the solid electrolyte laminated sheet, and a positive electrode active material layer are laminated and pressure-bonded in this order. This layer structure has, on the negative electrode collector, a porous support after laminating and pressure-bonding the porous support of the solid electrolyte laminated sheet (hereinafter, also referred to as an in-battery porous support), a solid electrolyte layer after laminating and pressure-bonding the solid electrolyte layer of the solid electrolyte laminated sheet (hereinafter, also referred to as an in-battery solid electrolyte layer), and a positive electrode active material layer in this order. In other words, this layer structure has the negative electrode collector on the surface of the in-battery porous support on a side opposite to the in-battery solid electrolyte layer and the positive electrode active material layer on the surface of the in-battery solid electrolyte layer on a side opposite to the in-battery porous support.

In the present invention, unless otherwise specified, the all-solid state secondary battery includes a form having a negative electrode active material layer formed (disposed) in advance (may be referred to as a form in which a negative electrode active material layer is formed in advance) and a form in which the negative electrode active material layer is not formed in advance and a metal (a layer thereof) obtained by reducing and precipitating, on the negative electrode side, metal ions generated in the positive electrode active material layer due to charging is used as the negative electrode active material layer (may be referred to as a form in which the negative electrode active material layer is not formed in advance, and an all-solid state secondary battery having this form may be referred to as a self-forming negative electrode type all-solid state secondary battery). In the self-forming negative electrode type all-solid state secondary battery, it suffices that the metal (preferably metallic lithium) may be precipitated at least in the in-battery porous support (generally in the voids), and further, it may be precipitated, as appropriate, on the surface of the negative electrode collector (in an interface between the in-battery porous support and the negative electrode collector), in an interface between the in-battery porous support and the in-battery solid electrolyte layer, and further in the in-battery solid electrolyte layer.

In a case where metallic lithium is employed as a metal to be precipitated, a theoretical capacity of 10 times or more is obtained as compared with graphite which is generally used as a negative electrode active material of a general all-solid state secondary battery, and the self-forming negative electrode type all-solid state secondary battery can realize a high energy density since the battery can be formed thinner as much as the negative electrode active material layer is not formed in advance.

As described above, the self-forming negative electrode type all-solid state secondary battery includes both aspects of an uncharged aspect (an aspect in which the metal constituting the negative electrode active material layer is not precipitated) and a charged aspect (an aspect in which the metal constituting the negative electrode active material layer is precipitated). It is noted that the fact that “the metal is not precipitated” includes, in addition to an aspect in which the metal is completely ionized and dissolved, an aspect in which the metal partially remains to an extent where the effect of the present invention is not impaired.

In the present invention, “charged” means a state in which charging is in progress in addition to a state in which charging is completed, and “charged” means a state in which discharging is completed.

In the present invention, the self-forming negative electrode type all-solid state secondary battery means that the negative electrode active material layer is not formed in the layer forming step in the battery manufacturing, and as described above, the negative electrode active material layer is formed by charging.

In the layer structure, another layer described later may be interposed between the respective layers, or the respective layers may be adjacent to each other. The in-battery porous support and the in-battery solid electrolyte layer may have a dendrite penetration blocking layer interposed between the layers, which will be described later; however, they are preferably adjacent to each other. It is preferable that the in-battery solid electrolyte layer and the positive electrode active material layer are adjacent to each other. On the other hand, the negative electrode collector and the in-battery porous support have preferred laminated states different from each other depending on the form of the all-solid state secondary battery. For example, in a case in which the negative electrode active material layer is formed in advance, it is preferable that in the negative electrode active material layer and the in-battery porous support, the negative electrode collector is interposed between the layers, whereby three layers are adjacent to each other. On the other hand, in a case in which the negative electrode active material layer is not formed in advance, it is preferable that the negative electrode collector and the in-battery porous support are adjacent to each other. In the present invention, the fact that layers are adjacent to each other means that the surfaces of the layers are disposed (formed) in a state of being in contact with each other.

In the all-solid state secondary battery having the above-described layer structure, the void ratio of the in-battery porous support is 15% or more, and the void ratio of the in-battery solid electrolyte layer is 10% or less. This makes it possible to improve the cycle characteristics and prevent the occurrence of the short circuit.

The void ratio of each layer is measured by the following method. That is, it is calculated as an area ratio (in terms of percentage) obtained such that any cross-section of each layer is observed with a scanning electron microscope (SEM) at a magnification of 30,000 to obtain an SEM photographic image, from which a (total) area of voids in a visual field of 3 μm×2.5 m is subsequently determined, and this area is divided by a visual field area (7.5 μm²).

In the present invention, each layer constituting the all-solid state secondary battery may have a monolayer structure or a multilayer structure as long as a specific function is exhibited.

The all-solid state secondary battery according to the embodiment of the present invention is not particularly limited in the configuration as long as it has the above-described layer structure, and for example, a known configuration for an all-solid state secondary battery can be employed. For example, it is also preferable that the all-solid state secondary battery according to the embodiment of the present invention has an aspect in which a film of a metal capable of forming an alloy with lithium is provided on the surface of the in-battery porous support opposite to the in-battery solid electrolyte layer. In addition, a known dendrite penetration blocking layer can also be disposed between the in-battery porous support and the in-battery solid electrolyte layer.

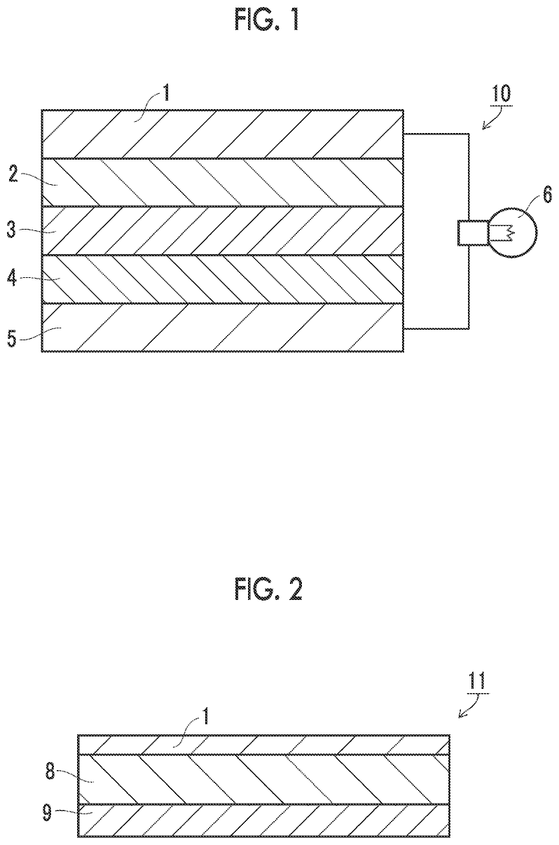

FIG. 1 is a cross-sectional view schematically illustrating a laminated state (layer structure) of respective constitutional layers constituting a battery for one embodiment of the self-forming negative electrode type all-solid state secondary battery (having the uncharged aspect) according to the embodiment of the present invention. A self-forming negative electrode type all-solid state secondary battery 10 according to the embodiment of the present invention has a layer structure in which a negative electrode collector 1, an in-battery porous support 2, an in-battery solid electrolyte layer 3, a positive electrode active material layer 4, and a positive electrode collector 5 are laminated in this order as viewed from a negative electrode side, and the laminated layers are directly in contact.

In the self-forming negative electrode type all-solid state secondary battery having such a layer structure, an electrons (e⁻) are supplied to the negative electrode side during charging, and at the same time, the alkali metal or alkaline earth metal constituting the positive electrode active material is ionized, pass through (conduction occurs toward) the in-battery solid electrolyte layer 3, migrated to the in-battery porous support 2, and is bonded to electrons (reduced), whereby the alkali metal or the alkaline earth metal is precipitated. For example, in a case of a lithium ion secondary battery, lithium ions (Li⁺) are precipitated in the negative electrode. In this way, at least the alkali metal or alkaline earth metal precipitated in the in-battery porous support 2 is allowed to function as the negative electrode active material layer.

On the other hand, during discharging, the precipitated alkali metal or alkaline earth metal generates metal ions and electrons. The metal ions pass through (conduction occurs toward) the in-battery solid electrolyte layer 3 and are returned (migrate) to the positive electrode active material layer side, and the electrons are supplied to an operation portion 6 to reach the positive electrode collector 5. In an example of the self-forming negative electrode type all-solid state secondary battery 10 illustrated in the drawing, an electric bulb is employed as the operation portion 6 and is lit by discharging.

In the all-solid state secondary battery in which the negative electrode active material layer is formed in advance, the negative electrode active material layer (not illustrated in FIG. 1) is disposed, as described above, between the negative electrode collector 1 and the in-battery porous support 2. The action of the all-solid state secondary battery having this form is basically the same as that of the self-forming negative electrode type all-solid state secondary battery 10, except that the negative electrode active material layer does not disappear during discharging.

The all-solid state secondary battery according to the embodiment of the present invention, which has the above-described layer structure is preferably manufactured by a manufacturing method for an all-solid state secondary battery according to the embodiment of the present invention, which will be described later, using the solid electrolyte laminated sheet according to the embodiment of the present invention.

The all-solid state secondary battery according to the embodiment of the present invention suppresses the occurrence of the internal short circuit (over multiple cycles) at a high level and suppresses a decrease in discharge capacity even after repeated charging and discharging over multiple cycles, thereby exhibiting excellent cycle characteristics.

Although not yet clear, the details of the reason can be conceived as follows.

The all-solid state secondary battery according to the embodiment of the present invention has an in-battery porous support having a void ratio of 15% or more and an in-battery solid electrolyte layer having a void ratio of 10% or less, on the negative electrode collector.

As will be described later, this in-battery porous support internally contains (internally has) the inorganic solid electrolyte in the porous support (contains the inorganic solid electrolyte in the pores) and has voids sufficient for accommodating the alkali metal or alkaline earth metal (may be simply referred to as metal) that is precipitated. This makes it possible to precipitate and accumulate the metal in the in-battery porous support (voids) while suppressing the volume change. Moreover, the in-battery porous support constituted with the porous support as a basic skeleton is less likely to cause defects (cracking, breakage, disruption, and the like) (difficult to undergo self-destruction) by the precipitation and dissolution of the metal are unlikely to occur. In such an in-battery porous support, the metal is precipitated as an inorganic solid electrolyte internally contained in the inside of the porous support (inside the pores) or in a state of being in contact with a metal that has already been precipitated (in a state where an ion conduction path has been constructed by disposing the inorganic solid electrolyte in a proper position). Therefore, even in a case where the electron conductive material is not used in combination as in WO2020-196040A, the ion conduction path constructed in the in-battery porous support is maintained during dissolution, and the metal can be sequentially ionized to suppress the isolation of the non-dissolved metal. It is conceived that such precipitation and dissolution of the metal are not impaired even in a case where the all-solid state secondary battery is repeatedly charged and discharged.

On the other hand, the in-battery solid electrolyte layer has a small void ratio and thus can block the growth (penetration) of the dendrite toward the positive electrode. Moreover, even in a case where the all-solid state secondary battery is repeatedly charged and discharged, the in-battery porous support accommodates the precipitated metal and effectively suppresses the volume change and defects are hardly generated, and thus the volume change and the stress caused by the occurrence of the defect (self-destruction) is not propagated to the in-battery solid electrolyte layer. Therefore, although defects are generally likely to occur in a solid electrolyte layer having a small void ratio and being dense, the generation of defects is suppressed at a high level in the in-battery solid electrolyte layer even in a case where the all-solid state secondary battery is repeatedly charged and discharged, whereby the penetration of the dendrite toward the positive electrode can be effectively inhibited.

Due to a cooperation of the above-described actions of the in-battery porous support and the in-battery solid electrolyte layer, it is conceived that it is possible to effectively suppress a decrease in cycle characteristics (maintain an excellent charging and discharging efficiency) even after repeated charging and discharging, and it is also possible to effectively suppress the occurrence of the internal short circuit.

<Negative Electrode Collector>

An electron conductor can be used as the negative electrode collector 1.

The material that forms the negative electrode collector is not particularly limited; however, examples thereof include metal materials such as aluminum, copper, a copper alloy, stainless steel, nickel, and titanium, where nickel, copper, a copper alloy, or stainless steel is preferable. In addition, a material obtained by treating the surface of these metal materials with carbon, nickel, titanium, or silver (a material in which a thin film has been formed) can also be used.

Regarding the shape of the negative electrode collector, typically, a negative electrode collector having a film sheet shape is used; however, it is also possible to use net-shaped collectors, punched collectors, compacts of lath bodies, porous bodies, foaming bodies, molded bodies of fiber groups, and the like.

The thickness of the negative electrode collector (including the above-described thin film) is not particularly limited; however, it is preferably 1 to 500 μm. The surface of the negative electrode collector is preferably provided with asperity by means of surface treatment.

In the present invention, both the negative electrode collector and the positive electrode collector, which will be described later, may be collectively referred to as a collector.

<In-Battery Porous Support>

The in-battery porous support is constituted with a sheet-shaped porous support as a basic skeleton (base) and has, inside the pores, an inorganic solid electrolyte having ion conductivity of a metal belonging to Group 1 or Group 2 in the periodic table (usually attached to the pore surface). In addition, it is a layer which has a void ratio of 15% or more and can accommodate a metal that is precipitated inside (usually voids). Therefore, in the in-battery porous support, the metal can be accumulated in the voids inside the pores by charging and discharging, while suppressing volume change and further suppressing self-destruction. From the viewpoint that self-destruction due to volume change and growth of dendrites hardly occurs, this in-battery porous support differs in the characteristics and function thereof from the “easy-destruction layer” of JP2020-107594A, which is positively self-destructed.

In the all-solid state secondary battery according to the embodiment of the present invention, in a case where the void ratio of the in-battery porous support is 15% or more, the metal that is precipitated can be accommodated while suppressing the volume change, and high cycle characteristics can be realized. From the viewpoint of further improving the cycle characteristics, the void ratio of the in-battery porous support is preferably 20% or more. The void ratio can be set to a higher value by taking advantage of the characteristics that the in-battery porous support is not easily damaged. For example, it can be also set to 30% or more, and it is more preferably set to 35% or more. The upper limit of the void ratio is appropriately determined according to the amount of metal precipitated in the all-solid state secondary battery, and it is, for example, preferably 80% or less, more preferably 60% or less, and still more preferably 50% or less.

The void ratio of the in-battery porous support is a value calculated as an area ratio according to the above method.

The thickness of the in-battery porous support is not particularly limited and can be appropriately determined depending on the battery capacity (the amount of metal precipitated), the void ratio, and the like. For example, it can be set to 1 to 100 μm, and it is preferably 3 to 80 μm.

The in-battery porous support is preferably a pressure-compressed body of the in-sheet porous support, which will be described later.

It is preferable that the in-battery porous support exhibits metal ion conductivity, although it depends on the charging amount of the inorganic solid electrolyte. The metal ion conductivity exhibited by the in-battery porous support is not particularly limited and is appropriately set within a range (a range where the function as a constitutional layer of the secondary battery is exhibited) where the conduction (migration) of the metal ions generated from the metal is not impaired. The metal ion conductivity can be adjusted depending on the kind, content, and the like of the contained inorganic solid electrolyte. On the other hand, the in-battery porous support does not exhibit electron conductivity (has electron-insulating properties) in a discharged state of the all-solid state secondary battery. The electron-insulating properties of the in-battery porous support are not limited to the characteristics that the conduction rate is 0 (S/m) and include characteristics of exhibiting a conduction rate to the extent that after passing through the in-battery porous support, electrons are not conducted (migrated) to two layers that are adjacent to the in-battery porous support (the electron-insulating properties to the extent that the all-solid state secondary battery is not short circuited).

In a case where the all-solid state secondary battery is a self-forming negative electrode type all-solid state secondary battery, the in-battery porous support internally contains the precipitated metal as a negative electrode active material, in a charged state of the all-solid state secondary battery. The metal internally contained in the in-battery porous support varies depending on the capacity of the positive electrode active material layer and is not unambiguously determined.

The porous support constituting the in-battery porous support means a support having a large number of micropores (pores opened on the surface, through-holes, and the like), and it is possible to use a known sheet-shaped porous support without particular limitation. Examples of the porous material include a sponge-shaped molded body, a sheet-shaped molded body having a large number of through-holes, and a non-woven fabric, where a sheet-shaped molded body having a large number of through-holes or a non-woven fabric is preferable.

The material that forms the porous support is not particularly limited, and examples thereof include various resins, ceramics, and fibers, where resins or fibers are preferable. Examples of the resin include a natural fiber/polyethylene terephthalate (PET)/acrylic resin coating type composite resin, a fluorine-containing resin, a hydrocarbon-based thermoplastic resin, an acrylic resin, a polyurethane resin, a polyurea resin, a polyamide resin, a polyimide resin, a polyester resin, a polyether resin, a polycarbonate resin, and a cellulose derivative resin, and examples of the fiber include a natural fiber and a composite resin fiber. Among them, the above-described composite resin or the like is preferable from the viewpoint of exhibiting a suitable strength (to the extent that it is not crushed or significantly compressed) with respect to a pressurizing force during the manufacture of the all-solid state secondary battery.

From the viewpoint that the void ratio can be adjusted by compression with pressurization during the manufacture of the all-solid state secondary battery, the porous support is preferably the above-described sheet-shaped molded body made of a resin or a non-woven fabric.

The void ratio (the void ratio as a material) of the porous support itself is appropriately determined according to the material, the pressurizing force during the manufacture of the all-solid state secondary battery and the like, as well as the amount of metal precipitated in the all-solid state secondary battery. For example, from the viewpoint that the void ratios of the in-sheet porous support and the in-battery porous support described later can be easily set in a predetermined range, the void ratio can be set to 50% to 99%, more preferably can be set 60% to 97%, and still more preferably can be set to 70% to 95%.

The opening diameter of the porous support itself is appropriately determined in consideration of the ease of filling with the inorganic solid electrolyte. For example, it is preferably 0.1 to 50 μm and more preferably 1 to 20 μm in terms of the opening diameter measured by the following measuring method. For the opening diameter, ten openings in a region of 1 mm×1 mm are randomly selected in an SEM photographic image obtained by observing any surface of the porous support with an SEM at a magnification of 30,000, and equivalent circle diameters of the respective openings are determined to determine the arithmetic average value thereof, which is adopted as the opening diameter.

The thickness of the porous support itself is not particularly limited and is appropriately determined depending on the battery capacity (the amount of metal precipitated), void ratio, and the like. For example, it is preferably 1 μm or more and 1 mm or less, more preferably 3 to 300 μm, still more preferably 10 to 200 μm, and particularly preferably 20 to 100 μm.

As a manufacturing method for the porous support, a known method can be employed without particular limitation. Examples thereof include a method of producing a sheet-shaped molded body and then perforating it, a photoresist method as in Examples described later, and a general production method for a non-woven fabric.

The inorganic solid electrolyte may be contained in a film shape that covers the pore surface of the porous support; however, it is generally contained (attached) as particles on the pore surface. The content (filling amount) of the inorganic solid electrolyte contained in the porous support is not particularly limited and is appropriately determined in consideration of the void ratio of the porous support and the void ratio of the porous support itself. For example, it is preferably a content that reduces the void ratio of the porous support itself by 5% to 80% and more preferably a content that reduces the void ratio by 10% to 70% The inorganic solid electrolyte contained in the porous support in a particle shape is as described later. In general, particles of the inorganic solid electrolyte have a size smaller than the opening diameter of the porous support. This fact can be confirmed by carrying out observation when measuring the void ratio. The specific particle diameter is appropriately determined in consideration of the opening diameter, the void ratio, the content (filling amount), and the like; however, it is, for example, preferably 0.01 to 5 μm, more preferably 0.05 to 3 μm, and still more preferably 0.1 to 2 μm. In addition, the difference between the opening diameter and the particle diameter is appropriately determined; however, it is, for example, preferably 0.1 to 10 μm, more preferably 0.5 to 8 μm, and still more preferably 0.8 to 5 μm, from the viewpoint that the inorganic solid electrolyte is uniformly distributed in the porous support.

For the particle diameter of the inorganic solid electrolyte, ten particles of the inorganic solid electrolyte present in the void part in a predetermined region (for example, a region of 1 mm×1 mm) are selected in an SEM photographic image obtained by observing any cross section of the porous support with an SEM, and equivalent circle diameters of the respective particles are determined to determine the arithmetic average value thereof, which is adopted as the particle diameter.

The inorganic solid electrolyte contained in the in-battery porous support may be one kind or two or more kinds.

—Inorganic Solid Electrolyte—

In the present invention, the inorganic solid electrolyte is an inorganic solid electrolyte, where the solid electrolyte refers to a solid-form electrolyte capable of migrating ions therein. The inorganic solid electrolyte is clearly distinguished from the organic solid electrolyte (the polymeric electrolyte such as polyethylene oxide (PEO) or the organic electrolyte salt such as lithium bis(trifluoromethanesulfonyl)imide (LiTFSI)) since it does not include any organic substance as a principal ion-conductive material. In addition, the inorganic solid electrolyte is solid in a steady state and thus, typically, is not dissociated or liberated into cations and anions. Due to this fact, the inorganic solid electrolyte is also clearly distinguished from inorganic electrolyte salts of which cations and anions are dissociated or liberated in electrolytic solutions or polymers (LiPF₆, LiBF₄, lithium bis(fluorosulfonyl)imide (LiFSI), LiCl, and the like). The inorganic solid electrolyte is not particularly limited as long as it has an ion conductivity of a metal belonging to Group 1 or Group 2 in the periodic table and generally does not have electron conductivity.

As the inorganic solid electrolyte contained in the in-battery porous support, a solid electrolyte material that is typically used for an all-solid state secondary battery can be appropriately selected and used. Examples of the inorganic solid electrolyte include (i) a sulfide-based inorganic solid electrolyte, (ii) an oxide-based inorganic solid electrolyte, (iii) a halide-based inorganic solid electrolyte, and (iv) a hydride-based inorganic solid electrolyte. The sulfide-based inorganic solid electrolytes are preferably used from the viewpoint that it is possible to form a more favorable interface between the active material and the inorganic solid electrolyte.

In a case where the all-solid state secondary battery according to the embodiment of the present invention is a lithium ion battery, the inorganic solid electrolyte preferably has a lithium ion conductivity.

(i) Sulfide-Based Inorganic Solid Electrolyte

The sulfide-based inorganic solid electrolyte is preferably an electrolyte that contains a sulfur atom, has an ion conductivity of a metal belonging to Group 1 or Group 2 in the periodic table, and has electron-insulating properties. The sulfide-based inorganic solid electrolytes are preferably inorganic solid electrolytes which contain, as elements, at least Li, S, and P and have a lithium ion conductivity; however, the sulfide-based inorganic solid electrolytes may appropriately include elements other than Li, S, and P.

Examples of the sulfide-based inorganic solid electrolyte include a lithium ion-conductive inorganic solid electrolyte satisfying the composition represented by Formula (1).

Lₐ₁M_{b1}P_{c1}S_{d1}Aₑ₁ (1)

In the formula, L represents an element selected from Li, Na, or K and is preferably Li. M represents an element selected from B, Zn, Sn, Si, Cu, Ga, Sb, Al, or Ge. A represents an element selected from I, Br, Cl, or F. a1 to e1 represent the compositional ratios between the respective elements, and a1:b1:c1:d1:e1 satisfies 1 to 12:0 to 5:1:2 to 12:0 to 10. a1 is preferably 1 to 9 and more preferably 1.5 to 7.5. b1 is preferably 0 to 3 and more preferably 0 to 1. d1 is preferably 2.5 to 10 and more preferably 3.0 to 8.5. e1 is preferably 0 to 5 and more preferably 0 to 3.

The compositional ratios between the respective elements can be controlled by adjusting the amounts of raw material compounds blended to manufacture the sulfide-based inorganic solid electrolyte as described below.

The sulfide-based inorganic solid electrolytes may be non-crystalline (glass) or crystallized (made into glass ceramic) or may be only partially crystallized. For example, it is possible to use Li—P—S-based glass containing Li, P, and S or Li—P—S-based glass ceramic containing Li, P, and S.

The sulfide-based inorganic solid electrolytes can be manufactured by a reaction of at least two or more raw materials of, for example, lithium sulfide (Li₂S), phosphorus sulfide (for example, diphosphorus pentasulfide (P₂S₅)), a phosphorus single body, a sulfur single body, sodium sulfide, hydrogen sulfide, lithium halides (for example, LiI, LiBr, and LiCl), or sulfides of an element represented by M (for example, SiS₂, SnS, and GeS₂).

The ratio of Li₂S to P₂S₅ in Li—P—S-based glass and Li—P—S-based glass ceramic is preferably 60:40 to 90:10 and more preferably 68:32 to 78:22 in terms of the molar ratio, Li₂S:P₂S₅. In a case where the ratio between Li₂S and P₂S₅ is set in the above-described range, it is possible to increase a lithium ion conductivity. Specifically, the lithium ion conductivity can be preferably set to 1×10⁻⁴ S/cm or more and more preferably set to 1×10⁻³ S/cm or more. The upper limit is not particularly limited but practically 1×10⁻¹ S/cm or less.

As specific examples of the sulfide-based inorganic solid electrolytes, combination examples of raw materials will be described below. Examples thereof include Li₂S—P₂S₅, Li₂S—P₂S₅—LiCl, Li₂S—P₂S₅—H₂S, Li₂S—P₂S₅—H₂S—LiCl, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SiS₂—LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S-Ges₂-Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S-Sis₂—P₂S₅—LiI, Li₂S—SiS₂—LiI, Li₂S—SiS₂—Li₄SiO₄, Li₂S—SiS₂—Li₃PO₄, and Li₁₀GeP₂Si₂. The mixing ratio between the individual raw materials does not matter. Examples of the method of synthesizing a sulfide-based inorganic solid electrolyte material using the above-described raw material compositions include an amorphorization method. Examples of the amorphorization method include a mechanical milling method, a solution method, and a melting quenching method. This is because treatments at a normal temperature become possible, and it is possible to simplify manufacturing processes.

(ii) Oxide-Based Inorganic Solid Electrolyte

The oxide-based inorganic solid electrolyte is preferably an electrolyte that contains an oxygen atom, has an ion conductivity of a metal belonging to Group 1 or Group 2 in the periodic table, and has electron-insulating properties.

The ion conductivity of the oxide-based inorganic solid electrolyte is preferably 1×10⁻⁶ S/cm or more, more preferably 5×10⁻⁶ S/cm or more, and particularly preferably 1×10⁻⁵ S/cm or more. The upper limit is not particularly limited; however, it is practically 1×10⁻¹ S/cm or less.

Specific examples of the compound include LiₓₐLa_{ya}TiO₃ [xa=0.3 to 0.7 and ya=0.3 to 0.7](LLT), Li_{xb}La_{yb}Zr_{zb}M^{bb}_{mb}O_{nb} (M^{bb} is at least one element of Al, Mg, Ca, Sr, V, Nb, Ta, Ti, Ge, In or Sn, xb satisfies 5≤xb≤10, yb satisfies 1≤yb≤4, zb satisfies 1≤zb≤4, mb satisfies 0≤mb≤2, and nb satisfies 5≤nb≤20), Li_{xc}B_{yc}M^{cc}_{zc}O_{nc} (M^{cc} is at least one element of C, S, Al, Si, Ga, Ge, In, or Sn, xc satisfies 0≤xc≤5, yc satisfies 0≤yc≤1, zc satisfies 0≤zc≤1, and nc satisfies 0≤nc≤6), Li_{xd}(Al, Ga)_{yd}(Ti, Ge)_{zd}Si_{ad}P_{md}O_{nd} (1≤xd≤3, 0≤yd≤1, 0≤zd≤2, 0≤ad≤1, 1≤md≤7, 3≤nd≤13), Li₍₃₋₂ₓₑ₎M^{ee}ₓₑD^{ee}O (xe represents a number value of 0 or more and 0.1 or less, M^{ee} represents a divalent metal atom, and D^{ee} represents a halogen atom or a combination of two or more halogen atoms), Li_{xf}Si_{yf}O_{zf} (1≤xf≤5, 0≤yf≤3, 1≤zf≤10), Li_{xg}S_{yg}O_{zg} (1≤xg≤3, 0≤yg≤2, 1≤zg≤10), Li₃BO₃—Li₂SO₄, Li₂O—B₂O₃—P₂O₅, Li₂O—SiO₂, Li₆BaLa₂Ta₂O₁₂, Li₃PO_{(4-3/2w)}N_{w} (w satisfies w≤1), Li_{3.5}Zn_{0.25}GeO₄ having a lithium super ionic conductor (LISICON)-type crystal structure, La_{0.55}Li_{0.35}TiO₃ having a perovskite type crystal structure, LiTi₂P₃O₁₂ having a natrium super ionic conductor (NASICON)-type crystal structure, Li_{1+xh+yh}(Al, Ga)ₓₕ(Ti, Ge)₂₋ₓₕSi_{yh}P_{3-yh}O₁₂ (0≤xh≤1, 0≤yh≤1), Li₇La₃Zr₂O₁₂ (LLZ) having a garnet-type crystal structure.

In addition, a phosphorus compound containing Li, P, or O is also desirable. Examples thereof include lithium phosphate (Li₃PO₄) and LiPON in which a part of oxygen atoms in lithium phosphate are substituted with a nitrogen atom, LiPOD¹ (D¹ is at least one element selected from Ti, V, Cr, Mn, Fe, Co, Ni, Cu, Zr, Nb, Mo, Ru, Ag, Ta, W, Pt, Au, or the like).

Further, it is also possible to preferably use LiA¹ON (A¹ represents at least one element selected from Si, B, Ge, Al, C, Ga, or the like).

(iii) Halide-Based Inorganic Solid Electrolyte

The halide-based inorganic solid electrolyte is preferably a compound that contains a halogen atom, has an ion conductivity of a metal belonging to Group 1 or Group 2 in the periodic table, and has electron-insulating properties.

The halide-based inorganic solid electrolyte is not particularly limited; however, examples thereof include LiCl, LiBr, LiI, and compounds such as Li₃YBr₆ or Li₃YCl₆ described in ADVANCED MATERIALS, 2018, 30, 1803075. In particular, Li₃YBr₆ or Li₃YCl₆ is preferable.

(iv) Hydride-Based Inorganic Solid Electrolyte

The hydride-based inorganic solid electrolyte is preferably a compound that contains a hydrogen atom, has an ion conductivity of a metal belonging to Group 1 or Group 2 in the periodic table, and has electron-insulating properties.

The hydride-based inorganic solid electrolyte is not particularly limited; however, examples thereof include LiBH₄, Li₄(BH₄)₃I, and 3LiBH₄—LiCl.

The inorganic solid electrolyte internally contained in the in-battery porous support is preferably particles. The particle diameter (volume average particle diameter) in this case is not particularly limited; however, it is preferably in the same range as the particle diameter of the inorganic solid electrolyte contained in a particle shape in the porous support.

In addition to the inorganic solid electrolyte, the in-battery porous support may contain preferably one or two or more kinds of binders described later and appropriately one or two or more kinds of other components. In general, the in-battery porous support does not internally contain the positive electrode active material or the negative electrode active material (excluding the metal consisting of ions derived from the positive electrode active material layer); however, it internally contains a metal (the negative electrode active material) in a charged state.

—Binder—

The binder contained in the in-battery porous support is not particularly limited. Examples thereof include an organic polymer, and a known organic polymer that is used in an all-solid state secondary battery can be used. Examples of such an organic polymer include a fluorine-containing resin, a hydrocarbon-based thermoplastic resin, an acrylic resin, a polyurethane resin, a polyurea resin, a polyamide resin, a polyimide resin, a polyester resin, a polyether resin, a polycarbonate resin, and a cellulose derivative resin.

—Other Components—

Other components are not particularly limited; however, examples thereof include various additives. Examples thereof include a thickener, an anti-foaming agent, a leveling agent, a dehydrating agent, and an antioxidant. In addition, examples thereof include the inorganic solid electrolyte particles described in JP2020-107594A which have a metallic lithium on a surface, conductive particles such as carbon, and particles of a metal capable of forming an alloy with lithium. Regarding each of the above-described components described in JP2020-107594A, the content described in the description of JP2020-107594A can be appropriately referenced, and the content thereof is incorporated as it is as a part of the description of the present specification.

In addition, the in-battery porous support may contain the electron conductive particles described in WO2020-196040. However, as described above, in the all-solid state secondary battery according to the embodiment of the present invention, the ion conduction path is constructed (maintained) in the in-battery porous support during charging and discharging, and thus the electron conductive particles are not essentially contained. “The content is not essential” means that the content of the component internally contained in the in-battery porous support is 0% by mass in the total mass, and is contained in a content of less than 1% by mass. The contents of the inorganic solid electrolyte, the binder, and other components, which are internally contained in the in-battery porous support, are not particularly limited; however, the contents thereof are generally the same as the content in 100% by mass of the solid content of the composition for a porous support described later. It is noted that the total mass of each of the components internally contained in the in-battery porous support has the same meaning as 100% by mass of the solid content of the composition for a porous support.

The in-battery porous support can be produced by adjusting (reducing) the void ratio within a predetermined range by pressurizing the solid electrolyte laminated sheet according to the embodiment of the present invention to compress the in-sheet porous support in the lamination direction (thickness direction).

<In-Battery Solid Electrolyte Layer>

The in-battery solid electrolyte layer is disposed (laminated) on one surface (main surface) of the in-battery porous support directly or by interposing another layer. The in-battery solid electrolyte layer is constituted by containing an inorganic solid electrolyte having ion conductivity of a metal belonging to Group 1 or Group 2 in the periodic table, in general, particles thereof. In addition, it has voids between the particles of the inorganic solid electrolyte with a void ratio of 10% or less and thus is a layer denser than the in-battery porous support.

In a case where the void ratio of the in-battery solid electrolyte layer is 10% or less, it is possible to prevent the dendrite growing in the in-battery porous support from penetrating into the positive electrode active material layer, and it is possible to suppress the occurrence of the internal short circuit. From the viewpoint that the occurrence of the internal short circuit can be effectively suppressed, the void ratio of the in-battery solid electrolyte layer is preferably 8% or less and more preferably 7% or less. The lower limit of the void ratio is not particularly limited; however, it is practically 0.1% or more, and for example, it is preferably 1% or more. The difference between the void ratio of the in-battery porous support and the void ratio of the in-battery solid electrolyte layer is not particularly limited; however, it can be, for example, 5% or more, and it is preferably 5% to 40% and more preferably 5% to 30%.

The void ratio of the in-battery solid electrolyte layer is a value calculated as an area ratio according to the above method.

The thickness of the in-battery solid electrolyte layer is not particularly limited and can be appropriately determined. For example, from the viewpoint that the penetration of the dendrite can be effectively blocked, it is preferably 10 to 1,000 m, more preferably 20 to 500 μm, and still more preferably 20 to 100 μm.

The in-battery solid electrolyte layer is preferably a pressure-compressed body of an in-sheet solid electrolyte layer, which will be described later.

Similar to the in-battery porous support, the in-battery solid electrolyte layer exhibits metal ion conductivity but does not exhibit electron conductivity, and functions as a separator for both electrodes.

The inorganic solid electrolyte constituting the in-battery solid electrolyte layer is as described above, and the kind thereof may be the same as or different from the kind of the inorganic solid electrolyte contained in the in-battery porous support, where the same kind of solid electrolyte is preferable.

The inorganic solid electrolyte constituting the in-battery solid electrolyte layer is generally particles. The particle diameter of the inorganic solid electrolyte is not particularly limited; however, it is preferably 0.01 μm or more and more preferably 0.1 μm or more. The upper limit is preferably 100 μm or less and more preferably 50 μm or less. The particle diameter of the inorganic solid electrolyte particles shall be a value measured by the same method as the particle diameter of the inorganic solid electrolyte in the porous support.

It is noted that the particle diameter (volume average particle diameter) of the inorganic solid electrolyte particles used in the manufacture of the all-solid state secondary battery or the production of the solid electrolyte laminated sheet is not particularly limited; however, it can be set in the range of the diameter of each particle diameter of the inorganic solid electrolyte in the in-battery porous support or the in-battery solid electrolyte layer, depending on the in-battery porous support or in-battery solid electrolyte layer to be contained. The particle diameter of the inorganic solid electrolyte particles that are used for the production is measured by the following procedure. Using water (heptane in a case where the inorganic solid electrolyte is unstable in water), the inorganic solid electrolyte particles are diluted in a 20 mL sample bottle to prepare 1% by mass of a dispersion liquid. The diluted dispersion liquid sample is irradiated with 1 kHz ultrasonic waves for 10 minutes and is then immediately used for testing. Data collection is carried out 50 times using this dispersion liquid sample, a laser scattering-type particle size distribution analyzer LA-920 (product name, manufactured by Horiba Ltd.), and a quartz cell for measurement at a temperature of 25° C. to obtain the volume average particle diameter. Other detailed conditions and the like can be found in Japanese Industrial Standards (JIS) Z8828: 2013 “particle diameter Analysis-Dynamic Light Scattering” as necessary. Five samples per level are produced and measured, and the average values thereof are employed.

Although the inorganic solid electrolyte contained in the in-battery solid electrolyte layer may be one kind or two or more kinds, two or more kinds having average particle diameters different from each other is preferable. It is preferable that one kind thereof is particles having an average particle diameter larger than the opening diameter of the in-battery porous support, and the other one kind is particles having an average particle diameter smaller than the opening diameter of the in-battery porous support. This makes it possible to set the void ratio of the in-battery solid electrolyte layer to a small value within the above-described range. This fact can be confirmed by carrying out observation when measuring the void ratio.

The average particle diameter larger than the opening diameter is appropriately determined from the above-described range according to the opening diameter of the in-battery porous support. For example, from the viewpoint of preventing a solid electrolyte having an average particle diameter smaller than the opening diameter from falling into the voids of the porous support, and further from the viewpoint of ion conductivity, it is, for example, preferably 1 to 20 μm, more preferably 2 to 15 μm, and still more preferably 5 to 12 μm. On the other hand, the average particle diameter smaller than the opening diameter is appropriately determined according to the opening diameter of the in-battery porous support. For example, from the viewpoint that the void ratio is reduced by the invasion between solid electrolytes having an average particle diameter larger than the opening diameter, it is, for example, preferably 0.01 to 10 μm, more preferably 0.05 to 5 μm, and still more preferably 1 to 3 μm. The difference in diameter between the large average particle diameter and the small average particle diameter is, for example, preferably, 0.1 to 15 μm, more preferably 0.3 to 12 μm, and still more preferably 0.5 to 10 μm in terms of the void ratio. In addition, the diameter ratio [large average particle diameter/small average particle diameter] between the large average particle diameter and the small average particle diameter is, for example, preferably more than 1 20 or less μm, more preferably 1.5 to 15, and still more preferably 2 to 10 μm in terms of the void ratio.

The total content of the inorganic solid electrolyte in the in-battery solid electrolyte layer is not particularly limited; however, from the viewpoint of constructing the ion conduction path, it is preferably the same as the content in 100% by mass of the solid content of the composition for an in-sheet solid electrolyte, which will be described later. In a case where the in-battery solid electrolyte layer contains the two or more kinds of the above-described inorganic solid electrolytes, the content of each inorganic solid electrolyte is preferably the same as the content in 100% by mass of the solid content in the composition for an in-sheet solid electrolyte, which will be described later. In addition, 100% by mass of the solid content of the composition for an in-sheet solid electrolyte has the same meaning as the total mass of the in-battery solid electrolyte layer, and further, the total mass of the components constituting the in-battery solid electrolyte layer in the all-solid state secondary battery in an uncharged state.

The in-battery solid electrolyte layer contains the inorganic solid electrolyte and may contain preferably one or two or more kinds of binders described later and further, appropriately one or two or more kinds of the other components. Although the in-battery solid electrolyte layer does not generally contain the positive electrode active material or the negative electrode active material, a metal may be precipitated in a charged state.

The binder that is used for the in-battery solid electrolyte layer is appropriately selected from those described above; however, both binders contained in the in-battery porous support and the in-battery solid electrolyte layer may be the same kind or kinds different from each other.

The content of each of the binder and the other components in the in-battery solid electrolyte layer is not particularly limited; however, it is generally the same as the content in 100% by mass of the solid content of the composition for an in-sheet solid electrolyte, which will be described later.

It is noted that in general, the in-battery solid electrolyte layer does not contain, as other components, the inorganic solid electrolyte particles described in JP2020-107594A which has a metallic lithium on a surface, conductive particles such as carbon, and particles of a metal capable of forming an alloy with lithium.

The solid electrolyte layer can be formed according to a conventional method using an inorganic solid electrolyte.

The in-battery solid electrolyte layer can be produced by reducing the void ratio to a predetermined range by pressurizing the solid electrolyte laminated sheet according to the embodiment of the present invention to compress the in-sheet solid electrolyte layer in the lamination direction (thickness direction).

<Positive Electrode Active Material Layer>

The positive electrode active material layer contains the positive electrode active material and has a function of generating metal ions by charging and supplying the metal ions to the in-battery porous support.

The thickness of the positive electrode active material is appropriately determined depending on the amount of lithium ions to be supplied and the like, and it is, for example, preferably 10 to 1,000 μm and more preferably 20 to 500 μm.

The positive electrode active material layer preferably contains an inorganic solid electrolyte having an ion conductivity of a metal belonging to Group 1 or Group 2 in the periodic table, a conductive auxiliary agent, a binder, and other components within a range where the effect of the present invention is not impaired. In addition, in an uncharged state of the all-solid state secondary battery, an aspect in which the negative electrode active material precursor described in JP2020-107594A is contained is one of the preferred aspects.

The inorganic solid electrolyte, binder, and other components contained in the positive electrode active material layer respectively have the same meanings as those described in the in-battery porous support. Regarding the negative electrode active material precursor and action thereof, the content described in JP2020-107594A can be appropriately referenced, and the content thereof is incorporated as it is as a part of the description of the present specification.

—Positive Electrode Active Material—

The positive electrode active material may be any active material capable of intercalating and deintercalating an ion of a metal belonging to Group 1 or Group 2 of the periodic table, and it is preferably one capable of reversibly intercalating and deintercalating a lithium ion. The above-described material is not particularly limited as long as the material has the above-described characteristics and examples thereof include a transition metal oxide, an organic substance, an element capable of being complexed with Li such as sulfur, a complex of sulfur, and a metal.

Among the above, as the positive electrode active material, transition metal oxides are preferably used, and transition metal oxides having a transition metal element Ma (one or more elements selected from Co, Ni, Fe, Mn, Cu, and V) are more preferable. In addition, an element Mb (an element of Group 1 (Ia) of the metal periodic table other than lithium, an element of Group 2 (IIa), or an element such as Al, Ga, In, Ge, Sn, Pb, Sb, Bi, Si, P, or B) may be mixed into this transition metal oxide. The mixing amount thereof is preferably 0% to 30% by mole of the amount (100% by mole) of the transition metal element Ma. It is more preferable that the transition metal oxide is synthesized by mixing the above components such that a molar ratio Li/Ma is 0.3 to 2.2.

Specific examples of the transition metal oxides include transition metal oxides having a bedded salt-type structure (MA), transition metal oxides having a spinel-type structure (MB), lithium-containing transition metal phosphoric acid compounds (MC), lithium-containing transition metal halogenated phosphoric acid compounds (MD), and lithium-containing transition metal silicate compounds (ME).

Specific examples of the transition metal oxides having a bedded salt-type structure (MA) include LiCoO₂ (lithium cobalt oxide [LCO]), LiNi₂O₂ (lithium nickelate), LiNi_{0.85}Co_{0.10}Al_{0.05}O₂ (lithium nickel cobalt aluminum oxide [NCA]), LiNi_{1/3}Co_{1/3}Mn_{1/3}O₂ (lithium nickel manganese cobalt oxide [NMC]), and LiNi_{0.5}Mn_{0.5}O₂ (lithium manganese nickelate).

Specific examples of the transition metal oxides having a spinel-type structure (MB) include LiMn₂O₄(LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compound (MC) include olivine-type iron phosphate salts such as LiFePO₄ and Li₃Fe₂(PO₄)₃, iron pyrophosphates such as LiFeP₂O₇, and cobalt phosphates such as LiCoPO₄, and a monoclinic NASICON type vanadium phosphate salt such as Li₃V₂(PO₄)₃ (lithium vanadium phosphate).

Examples of the lithium-containing transition metal halogenated phosphoric acid compound (MD) include iron fluorophosphates such as Li₂FePO₄F, manganese fluorophosphates such as Li₂MnPO₄F, cobalt fluorophosphates such as Li₂CoPO₄F.

Examples of the lithium-containing transition metal silicate compounds (ME) include Li₂FeSiO₄, Li₂MnSiO₄, and Li₂CoSiO₄.

In the present invention, the transition metal oxide having a bedded salt-type structure (MA) is preferable, and LCO or NMC is more preferable.

The shape of the positive electrode active material is not particularly limited; however, it is preferably a particle shape. The particle diameter (the volume average particle diameter) of the positive electrode active material is not particularly limited. For example, it can be set to 0.1 to 50 μm. In order to allow the positive electrode active material to have a predetermined particle diameter, a general pulverizer or classifier may be used. A positive electrode active material obtained using a baking method may be used after being washed with water, an acidic aqueous solution, an alkaline aqueous solution, or an organic solvent. An average particle diameter of the positive electrode active material particles can be measured by the same method as the above described measuring method for the average particle diameter of the inorganic solid electrolytes.

The surface of the positive electrode active material may be coated with a separate metal oxide. Examples of the surface coating agent include metal oxides and the like containing Ti, Nb, Ta, W, Zr, Al, Si, or Li. Specific examples thereof include titanium oxide spinel, tantalum-based oxides, niobium-based oxides, and lithium niobate-based compounds, and specific examples thereof include Li₄TisOi₂, Li₂Ti₂O₅, LiTaO₃, LiNbO₃, LiAlO₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, and B₂O₃.

In addition, a surface treatment may be carried out on the surfaces of electrodes including the positive electrode active material using sulfur, or phosphorous.

Furthermore, a surface treatment may be carried out on the surfaces of particles of the positive electrode active material with an actinic ray or an active gas (plasma or the like) before or after the coating of the surfaces.

The positive electrode active material contained in the positive electrode active material layer may be one kind or two or more kinds.

—Conductive Auxiliary Agent—

The conductive auxiliary agent that is preferably contained in the positive electrode active material layer is not particularly limited, and a conductive auxiliary agent that is known as an ordinary conductive auxiliary agent can be used. It may be, for example, graphite such as natural graphite and artificial graphite, carbon black such as acetylene black, Ketjen black, and furnace black, amorphous carbon such as needle cokes, carbon fibers such as a vapor-grown carbon fiber and a carbon nanotube, or a carbonaceous material such as graphene or fullerene, which are electron-conductive materials, and it may be also a metal powder or metal fiber of copper, nickel, or the like. A conductive polymer such as polyaniline, polypyrrole, polythiophene, polyacetylene, or a polyphenylene derivative may also be used.

In the present invention, in a case where the positive electrode active material is used in combination with the conductive auxiliary agent, among the above-described conductive auxiliary agents, a conductive auxiliary agent that does not intercalate and deintercalate ions (preferably Li ions) of a metal belonging to Group 1 or Group 2 in the periodic table and does not function as a positive electrode active material at the time of charging and discharging of the battery is classified as the conductive auxiliary agent. Therefore, among the conductive auxiliary agents, a conductive auxiliary agent that can function as the positive electrode active material in the positive electrode active material layer during charging and discharging of the battery is classified as a positive electrode active material not as a conductive auxiliary agent. Whether or not the conductive auxiliary agent functions as the positive electrode active material at the time of charging and discharging of a battery is not unambiguously determined; however, it is determined by the combination with the conductive auxiliary agent.

The shape of the conductive auxiliary agent is not particularly limited; however, it is preferably a particle shape. The particle diameter is not particularly limited; however, it is preferably 0.05 to 10 μm and more preferably 0.1 to 5 μm. The particle diameter is a value measured using the same method as that of the average particle diameter of the inorganic solid electrolyte.

One kind of conductive auxiliary agent may be contained, or two or more kinds thereof may be contained.

The content of each of the components (the positive electrode active material, the inorganic solid electrolyte, the conductive auxiliary agent, the binder, the negative electrode active material precursor, and the other components) in the positive electrode active material layer is not particularly limited; however, in general, it is the same as the content in 100% by mass of the solid component of the positive electrode composition described later. It is noted that 100% by mass of the solid content of the positive electrode composition has the same meaning as the total mass of all the components constituting the positive electrode active material layer.

<Negative Electrode Active Material Layer>

In a case of a form in which the negative electrode active material layer is formed in advance, the all-solid state secondary battery according to the present invention has a negative electrode active material layer between the negative electrode collector and the in-battery porous support even in an uncharged state.

The thickness of the negative electrode active material is appropriately determined and, for example, is preferably 10 to 1,000 μm and more preferably 20 to 500 μm. In a case where a layer consisting of the following negative electrode active material is employed as the negative electrode active material layer, the thickness thereof can be, for example, 0.01 to 100 μm regardless of the above-described thickness. It is noted that the thickness of the negative electrode active material layer to be formed in the form in which the negative electrode active material layer is not formed in advance varies depending on the amount of metal precipitated by charging and the forming amount in the in-battery porous support, and thus the thickness is not unambiguously determined.

The negative electrode active material layer may be any layer containing the negative electrode active material, and examples thereof include a layer consisting of a negative electrode active material, and a layer in which a negative electrode composition described later has been formed into a film.

The layer consisting of the negative electrode active material is preferably a metal thin film and more preferably a thin film of metallic lithium (a metallic lithium foil) that makes it possible to realize a high capacity of the all-solid state secondary battery. The metal thin film includes, for example, a layer formed by depositing or molding a metal powder, a metal foil, a metal vapor deposition film.

Examples of the layer in which the negative electrode composition has been formed into a film include a layer containing a negative electrode active material, preferably an inorganic solid electrolyte having an ion conductivity of a metal belonging to Group 1 or Group 2 in the periodic table, a conductive auxiliary agent, a binder, and other components within a range where the effect of the present invention is not impaired.

The inorganic solid electrolyte, binder, and other components contained in the negative electrode active material layer respectively have the same meanings as those described in the in-battery porous support. The conductive auxiliary agent has the same meaning as that described in the positive electrode active material layer.

—Negative Electrode Active Material—

The negative electrode active material is an active material capable of intercalating and deintercalating an ion of a metal belonging to Group 1 or Group 2 of the periodic table, and it is preferably one capable of reversibly intercalating and deintercalating a lithium ion. The material is not particularly limited as long as it has the above-described characteristics, and examples thereof include a carbonaceous material, a metal oxide, a metal composite oxide, a lithium single body, a lithium alloy, and a negative electrode active material that is capable of forming an alloy (capable of being alloyed) with lithium. Among the above, a carbonaceous material, a metal composite oxide, or a lithium single body is preferably used from the viewpoint of reliability. An active material that is capable of being alloyed with lithium is preferable since the capacity of the all-solid state secondary battery can be increased. In a case of using a negative electrode active material capable of forming an alloy with lithium, as the negative electrode active material, it is possible to increase the capacity of the all-solid state secondary battery and extend battery life.

The carbonaceous material that is used as the negative electrode active material is a material substantially consisting of carbon. Examples thereof include petroleum pitch, carbon black such as acetylene black (AB), graphite (natural graphite, artificial graphite such as vapor-grown graphite), and carbonaceous material obtained by baking a variety of synthetic resins such as polyacrylonitrile (PAN)-based resins or furfuryl alcohol resins. Furthermore, examples thereof also include a variety of carbon fibers such as PAN-based carbon fibers, cellulose-based carbon fibers, pitch-based carbon fibers, vapor-grown carbon fibers, dehydrated polyvinyl alcohol (PVA)-based carbon fibers, lignin carbon fibers, vitreous carbon fibers, and activated carbon fibers, mesophase microspheres, graphite whisker, and tabular graphite.

These carbonaceous materials can be classified into non-graphitizable carbonaceous materials (also referred to as “hard carbon”) and graphitizable carbonaceous materials based on the graphitization degree. In addition, it is preferable that the carbonaceous material has the surface spacing, density, and crystallite size described in JP1987-22066A (JP-S₆₂-22066A), JP1990-6856A (JP-H2-6856A), and JP1991-45473A (JP-H3-45473A). The carbonaceous material is not necessarily a single material and, for example, may be a mixture of natural graphite and artificial graphite described in JP1993-90844A (JP-H5-90844A) or graphite having a coating layer described in JP1994-4516A (JP-H6-4516A).

As the carbonaceous material, hard carbon or graphite is preferably used, and graphite is more preferably used.

The oxide of a metal or a metalloid element that is applied as the negative electrode active material is not particularly limited as long as it is an oxide capable of intercalating and deintercalating lithium, and examples thereof include an oxide of a metal element (metal oxide), a composite oxide of a metal element or a composite oxide of a metal element and a metalloid element (collectively referred to as “metal composite oxide), and an oxide of a metalloid element (a metalloid oxide). The oxides are more preferably noncrystalline oxides, and preferred examples thereof include chalcogenides which are reaction products between metal elements and elements in Group 16 of the periodic table). In the present invention, the metalloid element refers to an element having intermediate properties between those of a metal element and a non-metal element. Typically, the metalloid elements include six elements including boron, silicon, germanium, arsenic, antimony, and tellurium, and further include three elements including selenium, polonium, and astatine. In addition, “noncrystalline” represents an oxide having a broad scattering band with an apex in a range of 200 to 40° in terms of 2θ value in case of being measured by an X-ray diffraction method using CuKα rays, and the oxide may have a crystalline diffraction line. The highest intensity in a crystalline diffraction line observed in a range of 40° to 70° in terms of 2θ value is preferably 100 times or less and more preferably 5 times or less with respect to the intensity of a diffraction line at the apex in a broad scattering band observed in a range of 20° to 40° in terms of 2θ value, and it is particularly preferable that the oxide does not have a crystalline diffraction line.

In the compound group consisting of the noncrystalline oxides and the chalcogenides, noncrystalline oxides of metalloid elements and chalcogenides are more preferable, and (composite) oxides consisting of one element or a combination of two or more elements selected from elements (for example, Al, Ga, Si, Sn, Ge, Pb, Sb, and Bi) belonging to Groups 13 (IIIB) to 15 (VB) in the periodic table or chalcogenides are particularly preferable. Specific examples of the preferred noncrystalline oxide and chalcogenide preferably include Ga₂O₃, GeO, PbO, PbO₂, Pb₂O₃, Pb₂O₄, Pb₃O₄, Sb₂O₃, Sb₂O₄, Sb₂O₈Bi₂O₃, Sb₂O₈Si₂O₃, Sb₂O₅, Bi₂O₃, Bi₂O₄, GeS, PbS, PbS₂, Sb₂S₃, and Sb₂S₅.

Suitable examples of the negative electrode active material which can be used in combination with a noncrystalline oxide containing Sn, Si, or Ge as a major component include a carbonaceous material capable of intercalating and/or deintercalating lithium ions or metallic lithium, a lithium single body, a lithium alloy, and a negative electrode active material that is capable of being alloyed with lithium.

It is preferable that an oxide of a metal or a metalloid element, in particular, a metal (composite) oxide and the chalcogenide contain at least one of titanium or lithium as the constitutional component from the viewpoint of high current density charging and discharging characteristics. Examples of the metal composite oxide (lithium composite metal oxide) including lithium include a composite oxide of lithium oxide and the above metal (composite) oxide or the above chalcogenide, and specifically, Li₂SnO₂.

As the negative electrode active material, for example, a metal oxide (titanium oxide) having a titanium element is also preferable. Specifically, Li₄TisO₁ (lithium titanium oxide [LTO]) is preferable since the volume change during the intercalation and deintercalation of lithium ions is small, and thus the high-speed charging and discharging characteristics are excellent, and the deterioration of electrodes is suppressed, whereby it becomes possible to improve the life of the lithium ion secondary battery.

The lithium alloy as the negative electrode active material is not particularly limited as long as it is typically used as a negative electrode active material for a secondary battery, and examples thereof include a lithium aluminum alloy, and specifically, a lithium aluminum alloy, using lithium as a base metal, to which 10% by mass of aluminum is added.

The negative electrode active material capable of forming an alloy with lithium is not particularly limited as long as it is typically used as a negative electrode active material for a secondary battery. Such an active material has a large expansion and contraction due to charging and discharging of the all-solid state secondary battery. Examples of such an active material include a (negative electrode) active material (an alloy or the like) having a silicon element or a tin element and a metal such as Al or In, a negative electrode active material (a silicon element-containing active material) having a silicon element capable of exhibiting high battery capacity is preferable, and a silicon element-containing active material in which the content of the silicon element is 50% by mole or more with respect to all the constitutional elements is more preferable.

In general, a negative electrode including the negative electrode active material (for example, a Si negative electrode including a silicon element-containing active material or an Sn negative electrode containing an active material containing a tin element) can intercalate a larger amount of Li ions than a carbon negative electrode (for example, graphite or acetylene black). That is, the amount of Li ions intercalated per unit mass increases. As a result, the battery capacity (the energy density) can be increased. As a result, there is an advantage in that the battery driving duration can be extended.

Examples of the silicon element-containing active material include a silicon element-containing alloy (for example, LaSi₂, VSi₂, La—Si, Gd—Si, or Ni—Si) including a silicon material such as Si or SiOx (0≤x≤1) and titanium, vanadium, chromium, manganese, nickel, copper, lanthanum, or the like or a structured active material thereof (for example, LaSi₂/Si), and an active material such as SnSiO₃ or SnSiS₃ including silicon element and tin element. In addition, since SiOx itself can be used as a negative electrode active material (a metalloid oxide) and Si is produced along with the operation of an all-solid state secondary battery, SiOx can be used as a negative electrode active material (or a precursor material thereof) capable of being alloyed with lithium.

Examples of the negative electrode active material including the tin element include Sn, SnO, SnO₂, SnS, SnS₂, and the above-described active material including the silicon element and the tin element. In addition, a composite oxide with lithium oxide, for example, Li₂SnO₂ can also be used.

In the present invention, the above-described negative electrode active material can be used without any particular limitation. From the viewpoint of battery capacity, a preferred aspect as the negative electrode active material is a negative electrode active material that is capable of being alloyed with lithium. Among them, the silicon material or the silicon-containing alloy (the alloy containing a silicon element) described above is more preferable, and it is more preferable to include a negative electrode active material containing silicon (Si) or a silicon-containing alloy. Examples of the alloy containing a silicon element include LaSi₂, VSi₂, La—Si, Gd—Si, and Ni—Si.

The shape of the negative electrode active material is not particularly limited; however, it is preferably a particle shape. The average particle diameter (the volume average particle diameter) of the negative electrode active material is not particularly limited; however, it is preferably 0.1 to 60 μm. The average particle diameter of the negative electrode active material particles can be measured in the same manner as the average particle diameter of the inorganic solid electrolyte. In order to obtain the predetermined particle diameter, a typical pulverizer or classifier is used as in the case of the positive electrode active material. For example, a mortar, a ball mill, a sand mill, a vibration ball mill, a satellite ball mill, a planetary ball mill, a swirling air flow jet mill, or a sieve is suitably used. During crushing, it is also possible to carry out wet-type crushing in which water or an organic solvent such as methanol is made to coexist. In order to provide the desired particle diameter, classification is preferably carried out. A classification method is not particularly limited, and it is possible to use a sieve, a wind power classifier, or the like. Both the dry-type classification and the wet-type classification can be carried out.

In the present invention, the chemical formulae of compounds obtained using the baking method can be calculated using an inductively coupled plasma (ICP) emission spectroscopic analysis method as a measuring method or calculated from the mass difference of powder before and after baking as a convenient method.

The surface of the negative electrode active material may be subjected to surface coating with another metal oxide.

The negative electrode active material contained in the negative electrode active material layer may be one kind or two or more kinds.

The content of each of the components (the negative electrode active material, the inorganic solid electrolyte, the conductive auxiliary agent, the binder, and the other components) in the negative electrode active material layer is not particularly limited; however, in general, it is the same as the content in 100% by mass of the solid component of the negative electrode composition described later. It is noted that 100% by mass of the solid content of the negative electrode composition has the same meaning as the total mass of all the components constituting the negative electrode active material layer formed of the negative electrode composition.

The all-solid state secondary battery according to the embodiment of the present invention has each of the above-described layers and preferably or appropriately has the following constitutional layer.

<Positive Electrode Collector>

The all-solid state secondary battery according to the embodiment of the present invention preferably has a positive electrode collector.

An electron conductor can be used as the positive electrode collector.

The material that forms the positive electrode collector is not particularly limited; it is preferably not only aluminum, an aluminum alloy, stainless steel, nickel, or titanium but also a material (a material on which a thin film has been formed) obtained by treating the surface of aluminum or stainless steel with carbon, nickel, titanium, or silver is preferable. Among these, aluminum or an aluminum alloy is more preferable.

Regarding the shape of the positive electrode collector, a film sheet shape is typically used; however, it is also possible to use shapes such as a net shape, a punched shape, a lath body, a porous body, a foaming body, and a molded body of a fiber group.

The thickness of the positive electrode collector (including the thin film) is not particularly limited; however, it is preferably 1 to 500 μm. In addition, protrusions and recesses are preferably provided on the surface of the collector by carrying out a surface treatment.

In the present invention, a functional layer, a functional member, or the like may be appropriately interposed or disposed between or on the outside of the respective layers of the negative electrode collector, the negative electrode active material layer, the solid electrolyte layer, the positive electrode active material layer, and the positive electrode collector. In addition, each layer may be constituted of a single layer or multiple layers.

<Film of Metal Capable of Forming an Alloy with Lithium>

The all-solid state secondary battery according to the embodiment of the present invention may have a film of a metal capable of forming an alloy with lithium, between the negative electrode collector and the in-battery porous support. This metal film is generally provided to be disposed on the surface of the negative electrode collector (the surface disposed on the in-battery porous support side) or the surface of the in-battery porous support (the surface disposed on the negative electrode collector side).

The film of a metal capable of forming an alloy with lithium is not particularly limited as long as it is a metal film formed of a metal capable of forming an alloy with lithium. Examples of the metal capable of forming an alloy with lithium include each metal such as Zn, Bi, Mg in addition to Sn, Al, In, and the like, which are described in the negative electrode active material described above. Among them, Zn, Bi, or the like is preferable.

The thickness of this metal film is not particularly limited; however, it is preferably 300 nm or less, more preferably 20 to 100 nm, and still more preferably 30 to 50 nm.

In a case of incorporating this metal film into the all-solid state secondary battery, it is possible to effectively control the precipitation state of metallic lithium due to charging, and it is possible to effectively suppress the occurrence of the short circuit (it is possible to lengthen the time until the short circuit occurs (possible to increase the number of charging/discharging cycles).

Regarding the details of this metal film and the forming method thereof the content described in JP2020-107594A can be appropriately referenced, and the content thereof is incorporated as it is as a part of the description of the present specification.

<Dendrite Penetration Blocking Layer>

It is also preferable that the all-solid state secondary battery according to the embodiment of the present invention has a dendrite penetration blocking layer between the in-battery porous support and the positive electrode active material layer and preferably between the in-battery porous support and the in-battery solid electrolyte layer. As the dendrite penetration blocking layer, a known layer (film) can be used, or a dendrite penetration blocking layer can be appropriately produced. Examples of the known layer include a layer formed of an oxide-based inorganic solid electrolyte described later, for example, LiPON, and a layer formed by the method (the shear treatment or the heating treatment) described in JP2020-107594A. The void ratio of the dendrite penetration blocking layer produced by the method described in JP2020-107594A is preferably 3% or less and more preferably 1% or less.

The dendrite penetration blocking layer is generally formed to be a thin layer, and the thickness thereof is not particularly limited; however, it is, for example, preferably 0.001 to 100 μm and more preferably 0.01 to 10 μm.

Regarding the details of the preferred dendrite penetration blocking layer and the production method therefor, the content described in JP2020-107594A can be appropriately referenced, and the content thereof is incorporated as it is as a part of the description of the present specification.

<Housing>

Depending on the use application, the all-solid state secondary battery according to the embodiment of the present invention may be used as the all-solid state secondary battery having the above-described layer structure as it is; however, it is also preferably sealed in an appropriate housing to be used in the form of a dry cell. The housing may be a metallic housing or a resin (plastic) housing. In a case where a metallic case is used, examples thereof include an aluminum alloy case and a stainless steel case. It is preferable that the metallic housing is classified into a positive electrode-side housing and a negative electrode-side housing and that the positive electrode-side housing and the negative electrode-side housing are electrically connected to the positive electrode collector and the negative electrode collector, respectively. The positive electrode-side housing and the negative electrode-side housing are preferably integrated by being joined together through a gasket for short circuit prevention.

<Use Application of all-Solid State Secondary Battery>

The all-solid state secondary battery according to the embodiment of the present invention can be applied to a variety of usages. The application aspect thereof is not particularly limited, and in a case of being mounted in an electronic apparatus, examples thereof include a notebook computer, a pen-based input personal computer, a mobile personal computer, an e-book player, a mobile phone, a cordless phone handset, a pager, a handy terminal, a portable fax, a mobile copier, a portable printer, a headphone stereo, a video movie, a liquid crystal television, a handy cleaner, a portable CD, a mini disc, an electric shaver, a transceiver, an electronic notebook, a calculator, a portable tape recorder, a radio, a backup power supply, and a memory card. Additionally, examples of consumer usages include automobiles (electric vehicles and the like), electric vehicles, motors, lighting equipment, toys, game devices, road conditioners, watches, strobes, cameras, medical devices (pacemakers, hearing aids, and shoulder massage devices, and the like). Furthermore, the all-solid state secondary battery can be used for a variety of military usages and universe usages. In addition, the all-solid state secondary battery can also be combined with a solar battery.

[Solid Electrolyte Laminated Sheet]

The solid electrolyte laminated sheet according to the embodiment of the present invention is a sheet-shaped molded body that is suitably used in the manufacturing method for the all-solid state secondary battery of the present invention, which will be described later, and constitutes the in-battery porous support and the in-battery solid electrolyte layer in the all-solid state secondary battery according to the embodiment of the present invention.

The solid electrolyte laminated sheet according to the embodiment of the present invention contains a sheet-shaped porous support which internally contains an inorganic solid electrolyte having ion conductivity of a metal belonging to Group 1 or Group 2 in the periodic table (hereinafter, also referred to as an in-sheet porous support) and a solid electrolyte layer disposed on one surface of the in-sheet porous support, which contains an inorganic solid electrolyte having ion conductivity of a metal belonging to Group 1 or Group 2 in the periodic table (hereinafter, also referred to as an in-sheet solid electrolyte layer). The void ratio of the in-sheet porous support is 20% or more, and the void ratio of the in-sheet solid electrolyte layer is set to be smaller than the void ratio of the in-sheet porous support. The void ratio of each layer is measured according to the above-described measuring method.

In the solid electrolyte laminated sheet, the above-described other layer may be interposed between the in-sheet porous support and the in-sheet solid electrolyte layer; however, it is preferable that the in-sheet porous support and the in-sheet solid electrolyte layer are adjacent to each other. Various functional layers may be provided on a side of the in-sheet porous support opposite to the in-sheet solid electrolyte layer. As this functional layer, a different layer is disposed depending on the form of the all-solid state secondary battery to be manufactured. For example, in a case in which the negative electrode active material layer is formed in advance, it is preferable that the negative electrode active material layer and further, a base material (preferably, the negative electrode collector) are laminated, and all of these are adjacent to each other. On the other hand, in a case in which the negative electrode active material layer is formed in advance, it is preferable that the base material (preferably, the negative electrode collector) is laminated, and both layers are adjacent to each other. Examples of the functional layer include, in addition to the above-described layers, a protective layer (peeling sheet), and a coating layer as well.

The base material is not particularly limited as long as it is capable of supporting the solid electrolyte laminated sheet, and examples thereof include the materials described in the negative electrode or the positive electrode collector, and sheet-shaped bodies (plate-shaped bodies) of organic materials, inorganic materials, and the like. Examples of the organic materials include various polymers, and specific examples thereof include polyethylene terephthalate, polypropylene, polyethylene, and cellulose. Examples of the inorganic materials include glass, ceramic.

In the present invention, each layer constituting the solid electrolyte laminated sheet may have a monolayer structure or a multilayer structure as long as a specific function is exhibited.

The solid electrolyte laminated sheet according to the embodiment of the present invention is not particularly limited in the configuration as long as it has the above-described lamination structure, and a known configuration for a solid electrolyte laminated sheet can be employed. For example, it is also preferable that the solid electrolyte laminated sheet according to the embodiment of the present invention has an aspect in which the above-described film of a metal capable of forming an alloy with lithium is provided on the surface of the in-sheet porous support opposite to the in-sheet solid electrolyte layer. In addition, a known dendrite penetration blocking layer can also be disposed between the in-sheet porous support and the in-sheet solid electrolyte layer. Further, a positive electrode active material layer and further, a positive electrode collector may be provided on a side of the in-sheet solid electrolyte layer opposite to the in-sheet porous support.

The solid electrolyte laminated sheet according to the present invention is used in combination with a positive electrode sheet described later (as a sheet for pressure-bonding and lamination to a positive electrode sheet) preferably in the manufacturing method for an all-solid state secondary battery according to the present invention, and constitutes an all-solid state secondary battery.

FIG. 2 is a cross-sectional view schematically illustrating a laminated state of respective constitutional layers constituting a sheet for one embodiment of the solid electrolyte laminated sheet suitably used for the self-forming negative electrode type all-solid state secondary battery according to the embodiment of the present invention. This solid electrolyte laminated sheet 11 has a layer structure in which a negative electrode collector 1, an in-sheet porous support 8, and an in-sheet solid electrolyte layer 9 are laminated in this order, and the laminated layers are directly in contact.

In a case of being used for the manufacture of the all-solid state secondary battery in which the negative electrode active material layer is formed in advance, the negative electrode active material layer (not illustrated in FIG. 2) is disposed, as described above, between the negative electrode collector 1 and the in-sheet porous support 8.

The solid electrolyte laminated sheet according to the present invention is suitably used in the manufacturing method for the all-solid state secondary battery according to the embodiment of the present invention, which will be described later, and the solid electrolyte laminated sheet is pressurized to constitute the above-described in-battery porous support and in-battery solid electrolyte layer, which contributes to the suppression of the occurrence of the internal short circuit in the all-solid state secondary battery and the improvement of the cycle characteristics.

Although the solid electrolyte laminated sheet according to the embodiment of the present invention generally has a sheet shape, it includes a sheet (laminated sheet material) cut into a predetermined shape in the manufacture of the all-solid state secondary battery according to the embodiment of the present invention. Examples thereof include a laminated sheet material having a plate-shape or a disk-shape depending on the shape of the all-solid state secondary battery.

<Negative Electrode Collector>

The negative electrode collector preferably applied to the solid electrolyte laminated sheet according to the embodiment of the present invention is as described above in (has the same meaning as) the negative electrode collector in the all-solid state secondary battery.

<In-Sheet Porous Support>

The in-sheet porous support included in the solid electrolyte laminated sheet according to the present invention is a sheet-shaped porous support which internally contains an inorganic solid electrolyte having ion conductivity of a metal belonging to Group 1 or Group 2 in the periodic table. This in-sheet porous support is a layer that is incorporated into the all-solid state secondary battery to serve as the in-battery porous support. Therefore, the in-sheet porous support is the same as the above-described in-battery porous support, except that it is a porous support before being pressure-compressed and has a void ratio of 20% or more.

In a case where the void ratio of the in-sheet porous support is 20% or more, it is possible to suppress the reduction of the void ratio of the in-battery porous support to less than 15% (suppress the excessive compression of the in-sheet porous support) even in a case where pressure is applied in the manufacture of the all-solid state secondary battery, and it is possible to form an in-battery porous support having a predetermined void ratio by pressurization. The void ratio of the in-sheet porous support is not unambiguously determined since the range in which the above-described void ratio of the in-battery porous support can be achieved varies depending on the pressurizing force, the void ratio of the in-sheet solid electrolyte layer described later, and the like. As an example of enabling the above-described void ratio of the in-battery porous support as the void ratio of the in-sheet porous support, 40% or more is preferable, and 50% or more is more preferable. The upper limit of the void ratio is appropriately determined, and it is, for example, preferably 99% or less, more preferably 95% or less, and still more preferably 90% or less.

The thickness of the in-sheet porous support is not particularly limited and can be appropriately determined in consideration of the amount of compression or the like for forming the in-battery porous support since the amount of compression (the thickness) varies depending on the pressurizing force. For example, it can be set to 1 to 100 μm, and it is preferably 3 to 80 μm.

Each component (compound) internally contained in the in-sheet porous support and the content thereof are respectively the same as each component internally contained in the in-battery porous support and the content thereof. However, the standard of the content is the total mass of the components internally contained in the in-sheet porous support, and this total mass has the same meaning as 100% by mass of the solid content of the composition for incorporating the inorganic solid electrolyte and the like into the in-sheet porous support.

<In-Sheet Solid Electrolyte Layer>

The in-sheet solid electrolyte layer is disposed (laminated) on one surface (main surface) of the in-sheet porous support directly or by interposing another layer. The in-sheet solid electrolyte layer is constituted by containing an inorganic solid electrolyte having ion conductivity of a metal belonging to Group 1 or Group 2 in the periodic table, in general, particles thereof. This in-sheet solid electrolyte layer is a layer that is incorporated into the all-solid state secondary battery to serve as the in-battery solid electrolyte layer. Therefore, the in-sheet solid electrolyte layer is a solid electrolyte layer before being pressure compressed, is set to a void ratio smaller than that of the in-sheet porous support, and is the same as the above-described in-battery porous support, except that it is not specifically specified.

In a case where the void ratio of the in-sheet solid electrolyte layer is smaller than the void ratio of the in-sheet porous support, coupled with the fact that the in-sheet porous support has the porous support as the basic skeleton, both layers are pressurized once, whereby it is possible to form the in-battery porous support and the in-battery solid electrolyte layer, which have a predetermined void ratio in the above-described range.

As described above, the void ratio of the in-sheet solid electrolyte layer may be any void ratio smaller than that of the in-sheet porous support. However, the void ratio of the in-sheet solid electrolyte layer is not unambiguously determined since the range in which the above-described void ratio of the in-battery solid electrolyte layer can be achieved varies depending on the pressurizing force, the void ratio of the in-sheet porous support, and the like. As an example of the void ratio of the in-sheet solid electrolyte layer, 5% or more is preferable, 10% or more is more preferable, and 20% or more is more preferable, for example, from the viewpoint that the void ratios of the in-battery porous support and the in-battery solid electrolyte layer can be easily set within the above-described range, and further, from the viewpoint that the firm adhesiveness (the reduction of interlayer resistance) to the positive electrode active material layer can be realized in a case where the positive electrode active material layer is also pressure-bonded.

The difference between the void ratio of the in-sheet porous support and the void ratio (filling amount) of the in-sheet solid electrolyte layer is not particularly limited; however, it is, for example, preferably 5% to 90% and more preferably 10% to 50%.

The thickness of the in-sheet solid electrolyte layer is not particularly limited and can be appropriately determined in consideration of the amount of compression or the like for forming the in-battery solid electrolyte layer since the amount of compression (the thickness) varies depending on the pressurizing force. For example, it can be set to 1 to 150 μm, and it is preferably 3 to 100 μm.

Each component (compound) contained in the in-sheet solid electrolyte layer and the content thereof are respectively the same as each component contained in the in-battery solid electrolyte layer and the content thereof. However, the standard of the content is the total mass of the in-sheet solid electrolyte layer, and this total mass is the same as the total mass of the components constituting the in-sheet solid electrolyte layer and further, the same as 100% by mass of the solid content of the composition for forming the in-sheet solid electrolyte layer.

<Production Method for Solid Electrolyte Laminated Sheet>

A production method for the solid electrolyte laminated sheet according to the present invention is not particularly limited, and for example, the solid electrolyte laminated sheet can be produced by a method in which a composition for a porous support containing an inorganic solid electrolyte (a composition for internally containing an inorganic solid electrolyte or the like in an in-sheet porous support) is applied onto and impregnated into a porous support to form an in-sheet porous support, and then on this in-sheet porous support, a composition for an in-sheet solid electrolyte layer (a composition for forming an in-sheet solid electrolyte layer), which contains an inorganic solid electrolyte, is formed into a film.

Each layer of the in-sheet porous support and the in-sheet solid electrolyte layer may be formed individually, may be formed sequentially, or may be formed collectively as a laminate.

(Preparation of Composition)

In the production of the solid electrolyte laminated sheet, each of the composition for a porous support and the composition for an in-sheet solid electrolyte composition is prepared. The porous support constituting the in-sheet porous support is as described above.

Each of the composition for a porous support and the composition for an in-sheet solid electrolyte (may be referred to as each composition) contains an inorganic solid electrolyte, and may contain preferably a binder, dispersion medium, and further, other components as appropriate. Each component other than the dispersion medium, contained in each composition, is as described above.

—Dispersion Medium—

The dispersion medium that is used for the preparation of each composition may be any dispersion medium that disperses (dissolves) each of the above-described components contained in each composition. In the present invention, the dispersion medium is preferably a non-aqueous dispersion medium that does not contain water, and it is usually selected from organic solvents. In the present invention, the fact that the dispersion medium does not contain water includes an aspect in which the content of water is 0.10% by mass or less, in addition to an aspect in which the content of water is 0% by mass. However, the water content in each composition is preferably within the above-described range (for the non-aqueous composition).

The organic solvent is not particularly limited; however, examples thereof include respective solvents of an alcohol compound, an ether compound, an amide compound, an amine compound, a ketone compound, an aromatic compound, an aliphatic compound, a nitrile compound, and an ester compound.

The dispersion medium contained in each composition may be one kind or two or more kinds.

Each composition is preferably anon-aqueous composition. In the present invention, the non-aqueous composition includes not only an aspect not including moisture but also an aspect where the moisture content (also referred to as the “watery moisture content”) is 200 ppm or lower. The moisture content of the composition is preferably 150 ppm or lower, more preferably 100 ppm or lower, and still more preferably 50 ppm or lower. A water content amount indicates an amount of water (a mass ratio with respect to the electrode composition) contained in the electrode composition. The water content amount can be determined by filtering the electrode composition through a 0.45 μm membrane filter and Karl Fischer titration.

—Content of Each Composition—

The content of the inorganic solid electrolyte in each composition is not particularly limited. However, in terms of the binding property, it is preferably 80% by mass or more, more preferably 90% by mass or more, and particularly preferably 95% by mass or more in 100% by mass of the solid content. From the same viewpoint, the upper limit thereof is preferably 99.9% by mass or less, more preferably 99.5% by mass or less, and particularly preferably 99% by mass or less.

In a case where the composition for an in-sheet solid electrolyte contains the two or more kinds of the above-described inorganic solid electrolytes, the content of each inorganic solid electrolyte is appropriately determined in terms of the void ratio in consideration of the above-described total content. For example, in 100% by mass of the solid content, the content for the large particle diameter (average particle diameter) is preferably 0.1% to 90% by mass and more preferably 0.1% to 80% by mass, and it can be also set to 1% to 50% by mass. In addition, the lower limit value of the content for the large particle diameter can be set to 60% by mass or 70% by mass. On the other hand, the content for the small particle diameter (average particle diameter) is preferably 0.1% to 50% by mass and more preferably %5 to 25% by mass, and it can be also set to 5% to 10% by mass. The content difference between the large average particle diameter and the small average particle diameter is preferably 0.1% to 90% by mass, more preferably 10% to 90% by mass, and still more preferably 50% to 85% by mass. In addition, the content ratio [content for large average particle diameter/content for small average particle diameter] between the large average particle diameter and the small average particle diameter is, for example, preferably more than 1 and 20 or less, and more preferably 2 to 10.

The content of the binder in each composition is not particularly limited, and in 100% by mass of the solid content, it is, for example, preferably 0.10% to 10% by mass, more preferably 1% to 10% by mass, still more preferably 2% to 6% by mass, from the viewpoint of the reinforcement of the binding property of the solid particles and further, the adjustment of the void ratio and the like.

The contents of the other components in each composition are not particularly limited and are appropriately set.

The standard of the content of the composition is 100 parts by mass of the solid content of the composition. In the present invention, the solid content (solid component) refers to components that do not disappear by volatilization and evaporation in a case where the composition is dried at 130° C. for 6 hours in a nitrogen atmosphere at a pressure of 1 mmHg. Typically, the solid content refers to a component other than a dispersion medium.

The concentration of solid contents of the composition for a porous support is not particularly limited. However, from the viewpoint that each component in the composition, particularly the inorganic solid electrolyte can be filled into (invade into, be adhered to, or be disposed in) the pores of the porous support, the concentration may be any concentration that is not excessively high, and it is, for example, preferably 20% to 70% by mass, more preferably 30% to 65% by mass, and still more preferably 35% to 50% by mass.

On the other hand, the concentration of solid contents of the composition for an in-sheet solid electrolyte is not particularly limited. However, from the viewpoint that the pores of the porous support are not allowed to be filled with each component in the composition, it is preferably a high concentration and is, for example, preferably 40% to 80% by mass and more preferably 50% to 80% by mass. In this concentration of solid contents, in a case where the composition for an in-sheet solid electrolyte contains particles larger than and particles smaller than the opening diameter of the porous support, the invasion of particles into the porous support is suppressed even in a case of being small particles, whereby a solid electrolyte layer can be formed together with the large particles on the in-sheet porous support.

—Method of Preparing Composition—

Each composition can be prepared, for example, as a solid mixture or a slurry by mixing each of the above-described components with various mixers which are generally used.

The mixing method is not particularly limited and the mixing can be carried out using a known mixer such as a ball mill, a beads mill, or a disc mill. In addition, the mixing conditions are also not particularly limited. The mixing atmosphere may be any atmosphere such as atmospheric air, dry air (the dew point: −20° C. or lower), or inert gas (for example, an argon gas, a helium gas, or a nitrogen gas). Since the inorganic solid electrolyte reacts with watery moisture, the mixing is preferably carried out under dry air or in an inert gas.

(Support Forming Method and Film Forming Method)

A composition for a porous support and a composition for an in-sheet solid electrolyte is formed into a film by being applied (impregnated) and dried to form an in-sheet porous support, and an in-sheet solid electrolyte layer may be formed into a film.

As a coating method for the composition for a porous support and the composition for an in-sheet solid electrolyte, it is possible apply, for example, various coating methods such as spray coating, spin coating, dip coating, slit coating, stripe coating, bar coat coating, and coating using a baker type applicator, without particular limitation. In the formation of the in-sheet porous support, it is preferable that the composition for a porous support, which has been applied onto the porous support, is allowed to stand to impregnate the porous support (invade into the pores). The impregnation time in this case is not particularly limited and can be appropriately determined. The coating temperature and the impregnation temperature of each composition are not particularly limited. No heating is preferable, and for example, a temperature of 0° C. to 50° C. is preferable.

The drying temperature of both of the compositions is not particularly limited; however, the lower limit thereof is preferably 30° C. or higher, more preferably 60° C. or higher, and still more preferably 80° C. or higher. The upper limit of the drying temperature is preferably 300° C. or lower, more preferably 250° C. or lower, and still more preferably 200° C. or lower. In a case of carrying out heating in such a temperature range, the dispersion medium can be removed, and the composition for a porous support can be brought into a solid state (impregnated and dried state) to be adhered to (filled into) the pores of the porous support, and in addition, the composition for an in-sheet solid electrolyte layer can be brought into a solid state (coated and dried layer). The drying time is not particularly limited and is, for example, 0.3 to 5 hours. The coated and dried layer formed of the composition for an in-sheet solid electrolyte layer can also be pressurized. The pressurizing method is not particularly limited; however, press pressurization (for example, press pressurization using a hydraulic cylinder press machine) is preferable. The pressure is not particularly limited; however, it is set to a pressure such that the void ratio after pressurization is not smaller than the void ratio of the in-sheet porous support, and it can be, for example, 10 to 200 MPa. The coated and dried layer may be heated at the same time as the pressurization. The temperature in this case is not particularly limited; however, it is, for example, preferably 10° C. to 100° C.

It is preferable that the support forming method and the film forming method are carried out in the mixed atmosphere for each of the above-described compositions.

—Formation of In-Sheet Porous Support—

By employing the method, conditions, and the like described above, a porous support is coated with and then impregnated with the composition for a porous support, whereby it is possible to form an in-sheet porous support having a predetermined void ratio. In this case, it is preferable to dispose (place) the porous support on the surface of the base material.

The void ratio of the in-sheet porous support can be appropriately set depending on the void ratio of the porous support itself, the concentration of solid contents (the viscosity) of the composition for a porous support, each component contained in the composition for a porous support, and particularly the particle diameter of the inorganic solid electrolyte, the impregnation time, and further, the pressurizing force in a case of carrying out pressurization and the like. For example, in a case where the concentration of solid contents is decreased, the void ratio tends to decrease as the particle diameter of each component is decreased and in a case where the impregnation time is lengthened.

—Formation of Film of In-Sheet Solid Electrolyte Layer—

In addition, after forming the in-sheet porous support, a composition for an in-sheet solid electrolyte layer is formed into a film on this in-sheet porous support by employing the method, conditions, and the like described above, whereby it is possible to form the in-sheet solid electrolyte layer. The void ratio of the in-sheet solid electrolyte layer can be appropriately set depending on the void ratio of the porous support itself, the concentration of solid contents (the viscosity) of the composition for a porous support, each component contained in the composition for a porous support, and particularly the particle diameter of the inorganic solid electrolyte, and further, the pressurizing force in a case of carrying out pressurization and the like. For example, in a case where the concentration of solid contents is decreased, the void ratio tends to decrease as the particle diameter of each component is decreased and in a case where two or more kinds of inorganic solid electrolytes have particle diameters different from each other.

In the formation of a film of the in-sheet solid electrolyte layer, in a case of using a composition for an in-sheet solid electrolyte layer, which contains an inorganic solid electrolyte having a particle diameter smaller than the opening diameter of the in-sheet porous support, it is possible to use most of the inorganic solid electrolyte having a small particle diameter for the constitution of the in-sheet solid electrolyte layer without falling of the inorganic solid electrolyte having a small particle diameter into the pores of the porous support due to the concentration of solid contents of the composition, the coexistence of an inorganic solid electrolyte having a particle diameter larger than the opening diameter, and the like.

Examples of another production method for the in-sheet solid electrolyte layer include a method of forming a film of the composition for an in-sheet solid electrolyte layer (coating and drying) on a base material or forming the solid electrolyte layer by pressure-molding the composition for an in-sheet solid electrolyte layer, and then providing (pressure-bonding and laminating, or affixing) this on the in-sheet porous support. The base material to be used is not particularly limited; however, examples thereof include a sheet body (a plate-shaped body) of an organic material, an inorganic material, or the like. Examples of the organic materials include various polymers, and specific examples thereof include polyethylene terephthalate, polypropylene, polyethylene, and cellulose. Examples of the inorganic materials include glass, ceramic. The method and conditions for forming the composition for an in-sheet solid electrolyte layer are respectively the same as those in the above-described coating and drying method. The condition for pressure-bonding and laminating may be any condition as long as the solid electrolyte layer formed on the in-sheet porous support can be pressure-bonded and laminated. It is, for example, a condition of a pressure of 1 to 100 MPa, and preferred examples thereof include a condition of 10° C. to 100° C. The atmosphere for carrying out the pressure-bonding and lamination is the same as the mixing atmosphere during the preparation of each of the above-described compositions.

(Pressurization Step)

In the production of the solid electrolyte laminated sheet, after being produced as described above, the laminate of the in-sheet porous support and the in-sheet solid electrolyte layer can also be pressurized. The pressurizing method and the pressure are not particularly limited and are respectively the same as the pressurizing method and the pressure of the coated and dried layer.

In this way, a solid electrolyte laminated sheet having the in-sheet porous support and the in-sheet solid electrolyte layer can be produced. It is noted that the dispersion medium used in the preparation of each composition may be contained (allowed to remain) in each of the in-sheet porous support and the in-sheet solid electrolyte layer of the produced solid electrolyte laminated sheet as long as the effect of the present invention is not impaired. The residual amount can be set to, for example, 3% by mass or less in each layer.

[Manufacturing Method for all-Solid State Secondary Battery According to the Embodiment of Present Invention]

Next, the description will be made for the manufacturing method for a sheet for an all-solid state secondary battery according to the embodiment of the present invention (hereinafter, may be referred to as the manufacturing method according to the embodiment of the present invention).

The manufacturing method according to the embodiment of the present invention is a method of manufacturing an all-solid state secondary battery using the solid electrolyte laminated sheet according to the embodiment of the present invention, where the manufacturing method has a step of pressurizing the solid electrolyte laminated sheet until the solid electrolyte layer has a void ratio of 10% or less while suppressing a void ratio of the porous support of the solid electrolyte laminated sheet to 15% or more. This makes it possible to manufacture, with a simple method of pressure-bonding and lamination, an all-solid state secondary battery in which the occurrence of the internal short circuit is suppressed, and the cycle characteristics are also excellent.

In this step of pressurization, the solid electrolyte laminated sheet is preferably pressurized, not the solid electrolyte laminated sheet alone but together with the negative electrode collector or the positive electrode active material layer, to be pressure-bonded (pressurized and pressure-bonded, or pressure-bonded and laminated), and more preferably pressurized to be pressure-bonded and laminated to the positive electrode active material layer from the viewpoint that a layer structure essential for an all-solid state secondary battery can be manufactured in the step of pressurization, and moreover, the firm adhesion (the reduction of the interface resistance) to the positive electrode active material layer is possible.

In the pressure-bonding and lamination with the solid electrolyte laminated sheet according to the embodiment of the present invention, a positive electrode sheet consisting of a positive electrode active material layer can be used as the positive electrode active material layer; however, it is preferable to use a positive electrode sheet having a positive electrode collector and a positive electrode active material layer. The positive electrode active material layer and the positive electrode collector, which constitute the positive electrode sheet, are respectively the same as those in the above-described all-solid state secondary battery. However, since the positive electrode active material layer of the positive electrode sheet may become a thin layer by the pressure-bonding and lamination or the like, the thickness is determined to be a thickness required for the positive electrode active material layer of the all-solid state secondary battery even in a case of becoming a thin layer. This positive electrode sheet may have the other layer and the functional layer, which are described in the solid electrolyte laminated sheet.

Similar to the solid electrolyte laminated sheet, the positive electrode sheet has generally a sheet shape; however, it is also possible to use a sheet (a positive electrode sheet material) cut into a predetermined shape for use in the manufacturing method according to the embodiment of the present invention.

—Production of Positive Electrode Sheet—

The positive electrode sheet is produced by various known methods. For example, it is possible to produce the positive electrode sheet by forming a film of the positive electrode active material layer on the surface of the base material, preferably on the surface of the positive electrode collector. In this production method, first, a composition (a positive electrode composition) for forming a positive electrode active material layer is prepared.

The positive electrode composition contains a positive electrode active material, preferably an inorganic solid electrolyte, a conductive auxiliary agent, a binder, a dispersion medium, and further, other components as appropriate. Each component contained in the positive electrode composition is as described above.

The content of the positive electrode active material in the positive electrode composition is not particularly limited; however, it is preferably 10% to 95% by mass, more preferably 30% to 90% by mass, still more preferably 50% to 85% by mass, and particularly preferably 55% to 80% by mass in 100% by mass of the solid content.

In a case where the positive electrode composition contains an inorganic solid electrolyte, the content of the inorganic solid electrolyte in the positive electrode composition is not particularly limited. However, in terms of the total content of the positive electrode active material and the inorganic solid electrolyte, it is preferably 10% by mass or more, more preferably 15% by mass or more, still more preferably 50% by mass or more, particularly preferably 70% by mass or more, and most preferably 90% by mass or more in 100% by mass of the solid content. The upper limit thereof is not particularly limited and is, for example, preferably 99.9% by mass or less, more preferably 99.5% by mass or less, and still preferably 99% by mass or less in 100% by mass of the solid content.

The content of the conductive auxiliary agent in the positive electrode composition is not particularly limited and is preferably 0.1% to 20% by mass and more preferably 0.5% to 10% by mass in 100% by mass of the solid content.

The content of the binder in the positive electrode composition is not particularly limited, and in 100% by mass of the solid content, it is, for example, preferably 0.10% to 10% by mass, more preferably 1% to 10% by mass, still more preferably 2% to 6% by mass, from the viewpoint of the reinforcement of the binding property of the solid particles and further, the adjustment of the void ratio and the like.

The content of the dispersion medium in the positive electrode composition is not particularly limited and is preferably 20% to 80 mass %, more preferably 30% to 70 mass %, and particularly preferably 40% to 60 mass %.

The positive electrode composition is preferably a non-aqueous composition.

(Preparation of Positive Electrode Composition)

The positive electrode composition can be prepared, for example, as a solid mixture or a slurry by mixing each of the above-described components with various mixers which are generally used. The mixing method, mixing conditions, and the like are respectively the same as the preparation conditions for the above-described composition for a porous support and the like.

(Formation of Positive Electrode Active Material Layer)

The positive electrode active material layer is not particularly limited; however, it can be produced by a coating and drying method in which a positive electrode composition (slurry) is applied onto the surface of the base material, preferably onto the surface of the positive electrode collector, and then dried, by a molding method, or the like.

In any of the methods, the atmosphere during production is not particularly limited, and examples thereof include the mixed atmosphere for each of the above-described compositions.

The forming method for the positive electrode active material layer is the same as the forming method for the in-sheet solid electrolyte layer, except that the composition to be used and the surface to be formed are different. However, it is not necessary to positively adjust the void ratio in the formation of the positive electrode active material layer.

It is also possible to produce the positive electrode sheet by forming a film of the positive electrode active material layer using a base material instead of the positive electrode collector and providing (pressure-bonding and lamination or affixing) it on the positive electrode collector. The base material, the conditions for the pressure-bonding and lamination, and the like, which are used in this method, are respectively the same as those in the other production method for the in-sheet solid electrolyte layer of the solid electrolyte laminated sheet.

As described above, it is possible to produce the positive electrode sheet having a positive electrode active material layer preferably on the positive electrode collector.

<Pressure-Bonding and Lamination Step>

In the manufacturing method according to the embodiment of the present invention, the produced or prepared solid electrolyte laminated sheet and positive electrode sheet are pressure-bonded and laminated to each other by sequentially carrying out the following steps of superimposition and pressurization. That is, the manufacturing method according to the embodiment of the present invention is a method of forming the in-battery porous support and the in-battery solid electrolyte layer, in which a solid electrolyte laminated sheet having the in-sheet porous support and the in-sheet solid electrolyte layer is used to pressurize and integrate this laminated sheet with the positive electrode active material layer, whereby the in-sheet porous support and the in-sheet solid electrolyte layer are compressed to a predetermined void ratio to reduce the void ratio. This makes it possible to ensure a metal precipitation space in the in-battery porous support and concurrently densify the in-battery solid electrolyte layer. Further, it is also possible to make firm the interlayer adhesive force between the in-battery solid electrolyte layer and the positive electrode active material layer.

Step of superimposition: A step of causing the in-sheet solid electrolyte layer of the solid electrolyte laminated sheet and the positive electrode active material layer of the positive electrode sheet to face with each other, thereby superimposing the solid electrolyte laminated sheet and the positive electrode sheet Step of pressurization: A step of pressurizing the superimposed solid electrolyte laminated sheet and positive electrode sheet in the superimposition direction until the void ratio of the solid electrolyte layer reaches 10% or less while suppressing the void ratio of the porous support to 15% or more

In the present invention, “carrying out step sequentially” means a before and after relation in terms of the time elapsed for carrying out a certain step and another step, and includes an aspect in which another step (including a rest step) is carried out between the certain step and the other step. In addition, the aspect in which the certain step and the other step are carried out sequentially includes an aspect in which steps are carried out by changing the time, the place, or the practitioner.

—Step of Superimposition—

In the step of superimposition, it suffices that both sheets are laminated (stacked) by a conventional method, and by this step, the in-sheet solid electrolyte layer and the positive electrode active material layer are disposed to be in contact with each other (adjacent to each other).

—Step of Pressurization—

Next, while maintaining this superimposed state, the superimposed solid electrolyte laminated sheet and positive electrode sheet are pressurized (compressed) in the superimposed direction.

The pressurizing force in this case is set to a pressure at which the void ratio of the porous support (the in-battery porous support) after pressurization is suppressed to 15% or more (15% or more is maintained, that is, without being decreased to 15% or less), and moreover, the void ratio of the solid electrolyte layer (the in-battery solid electrolyte layer) after pressurization is (reaches) 10% or less. That is, in the step of pressurization, both sheets are pressurized to set the void ratio of the in-battery porous support to 15% or more and the void ratio of the in-battery solid electrolyte layer to less than 10%.

In the manufacturing method according to the embodiment of the present invention, the void ratio of the in-battery porous support after pressurization may be any value as long as it is not less than 15%, and is set to the void ratio of the in-battery porous support described above. The amount of reduction of the void ratio by pressurization (void ratio of in-sheet porous support before pressurization—void ratio thereof after pressurization) is not particularly limited; however, it is, for example, preferably 5% to 40% and more preferably 5% to 30%.

On the other hand, the void ratio of the in-battery solid electrolyte layer after pressurization may be any value as long as it is less than 10%, and is set to the above-described void ratio of the in-battery solid electrolyte layer described above. The amount of reduction of the void ratio by pressurization (void ratio of in-sheet solid electrolyte layer before pressurization—void ratio thereof after pressurization) is not particularly limited; however, it is, for example, preferably 10% to 60% and more preferably 20% to 50%.

The method of pressurization is not particularly limited, and various known pressurizing methods can be applied, where a press pressurizing method (for example, press pressurizing using a hydraulic cylinder press machine) is preferable.

The pressurizing force in the step of pressurization may be a pressure at which the void ratios of the in-battery porous support and the in-battery solid electrolyte layer are within the above-described range; however, it is not unambiguously determined since it varies depending on the void ratios of the in-sheet porous support and the in-sheet solid electrolyte layer, the void ratio after pressurization, and the like. For example, the pressurizing force can be set to 100 to 1,000 MPa, preferably can be set to 200 to 800 MPa, and more preferably can be set to 350 to 800 MPa. The pressurization time can be appropriately set. The step of pressurization may be carried out under heating; however, it is preferably carried out under non-heating, and for example, the pressure-bonding and laminating are preferably carried out at an environmental temperature of 0° C. to 50° C. In a case of carrying out pressurization under heating, the heating temperature is not particularly limited; however, it is generally in a range of 30° C. to 300° C.

In a case of pressurizing (pressure-bonding) the above-described solid electrolyte laminated sheet with respect to the positive electrode active material layer, the in-sheet porous support is not compressed until the void ratio is less than 15%, and the in-sheet solid electrolyte layer is compressed until the ratio is 10% or less.

The in-sheet solid electrolyte layer is densified by being pressurized until the void ratio of the in-sheet solid electrolyte layer (the in-battery solid electrolyte layer) after pressurization is 10% or less, as described above, and it is possible to block the growth of dendrites and the arrival thereof at the positive electrode active material layer. In addition, it is possible to improve the ion conductivity of the in-battery solid electrolyte layer, and concurrently it is possible to favorably join (firmly adhere (bond)) the contact interface between the in-battery solid electrolyte layer and the positive electrode active material layer, whereby it is possible to suppress the interface resistance to a low level.

In a case of setting the void ratio of the in-sheet porous support (the in-battery porous support) after pressurization to at least 15%, it is possible to allow voids to remain in the in-battery electron-ion conductive layer, thereby accommodating and accumulating the precipitated metal while suppressing volume change.

In a case of compressing each of the in-sheet porous support and the in-sheet solid electrolyte layer to a void ratio of 15% or more and 10% or less, as described above, the solid electrolyte laminated sheet is integrated with the positive electrode sheet.

In this way, it is possible to manufacture a self-forming negative electrode type all-solid state secondary battery (in a discharged state) having a layer structure in which at least the in-battery porous support, the in-battery solid electrolyte layer, and the positive electrode active material are laminated in this order, preferably a layer structure in which the negative electrode collector, the in-battery porous support, the in-battery solid electrolyte layer, the positive electrode active material, and the positive electrode collector are laminated in this order.

In the self-forming negative electrode type all-solid state secondary battery, a step of charging described later is carried out after the step of pressurization, to precipitate the metal (the negative electrode active material) in the in-battery porous support and further, between the negative electrode collector and the in-battery porous support, thereby capable of forming the negative electrode active material layer.

On the other hand, in the all-solid state secondary battery in which the negative electrode active material layer is formed in advance, a step of forming a negative electrode active material layer between the negative electrode collector and the porous support is carried out.

Examples of the step of forming a negative electrode active material layer include a step of pressure-bonding or laminating the solid electrolyte laminated sheet with the negative electrode active material layer and the negative electrode collector before, after, or at the same time as the pressurization and pressure-bonding to the positive electrode sheet, by using a solid electrolyte laminated sheet which does not include the negative electrode collector during the manufacture of the all-solid state secondary battery. In this step, the negative electrode active material layer formed by the following forming method can be pressurized and pressure-bonded, or laminated. However, it is preferable to laminate or, pressurize and pressure-bond the above-described layer consisting of the negative electrode active material, particularly the metallic lithium foil. In addition, examples of the step of forming a negative electrode active material layer also include a step of forming a negative electrode active material layer between the negative electrode collector and the in-sheet porous support during the production of the solid electrolyte laminated sheet. The forming method for the negative electrode active material layer, which is used in this step, is not particularly limited; however, the negative electrode active material layer can be produced by a method of forming a film of a negative electrode composition (slurry) on a base material, preferably on a surface of a negative electrode collector, similarly to the case of the positive electrode active material layer (a coating drying method of carrying out coating and then drying), by a molding method for pressure molding the negative electrode composition, or the like.

The atmosphere in which the step of forming the negative electrode active material layer is carried out is not particularly limited, and examples thereof include the mixed atmosphere for each of the above-described compositions.

The negative electrode composition for forming a negative electrode active material layer contains a negative electrode active material, preferably an inorganic solid electrolyte, a conductive auxiliary agent, a binder, a dispersion medium, and further, other components as appropriate. Each component contained in the negative electrode composition is as described above.

The content of the negative electrode active material in the negative electrode composition is not particularly limited, and it is preferably 100% by mass or less, more preferably 10% to 90% by mass, still more preferably 20% to 85% by mass, even still more preferably 30% to 80% by mass, and even further still more preferably 40% to 75% by mass, in 100% by mass of the solid content.

In a case where the negative electrode composition contains an inorganic solid electrolyte, the content of the inorganic solid electrolyte in the negative electrode composition is not particularly limited. However, in terms of the total content of the negative electrode active material and the inorganic solid electrolyte, it is preferably 10% by mass or more, more preferably 15% by mass or more, still more preferably 50% by mass or more, particularly preferably 70% by mass or more, and most preferably 90% by mass or more in 100% by mass of the solid content. The upper limit thereof is not particularly limited and is, for example, preferably 99.9% by mass or less, more preferably 99.5% by mass or less, and still preferably 99% by mass or less in 100% by mass of the solid content.

The content of the conductive auxiliary agent in the negative electrode composition is not particularly limited and is preferably 0.1% to 20% by mass and more preferably 0.5% to 10% by mass in 100% by mass of the solid content.

The content of the binder in the negative electrode composition is not particularly limited, and in 100% by mass of the solid content, it is, for example, preferably 0.1% to 10% by mass, more preferably 1% to 10% by mass, still more preferably 2% to 6% by mass, from the viewpoint of the reinforcement of the binding property of the solid particles and further, the adjustment of the void ratio and the like.

A total content of the dispersion medium in the negative electrode composition is not particularly limited; however, it is preferably 20% to 80% by mass, more preferably 30% to 70% by mass, and particularly preferably 40% to 60% by mass.

The negative electrode composition is preferably a non-aqueous composition.

The negative electrode composition can be prepared, for example, as a solid mixture or a slurry by mixing each of the above-described components with various mixers which are generally used. The mixing method, mixing conditions, and the like are respectively the same as the preparation conditions for the above-described composition for a porous support and the like.

In a case of forming a negative electrode active material layer between the negative electrode collector and the in-sheet porous support as described above, it is possible to manufacture an all-solid state secondary battery having a layer structure in which the negative electrode collector, the negative electrode active material layer, the in-battery porous support, the in-battery solid electrolyte layer, the positive electrode active material, and preferably the positive electrode collector are laminated in this order.

<Pressurization and Restraining>

The all-solid state secondary battery produced as described above is preferably pressurized and restrained in the lamination direction during the initialization or use thereof. The restraining force at this time is not particularly limited, but is preferably 0.05 MPa or more, and more preferably 1 MPa. The upper limit thereof is, for example, preferably less than 10 MPa and more preferably 8 MPa or less.

<Initialization>

The manufacturing method according to the present invention may have a step of initializing the all-solid state secondary battery (in a discharged state) obtained as above or may have a step of charging.

The initialization is generally carried out after the manufacture of the all-solid state secondary battery and before the use, and the step of charging and the step of discharging are each carried out at least once.

—Step of Charging—

The step of charging makes it possible supply metal ions from the positive electrode active material layer to at least the in-battery porous support (generally to the voids), and particularly, in the self-forming negative electrode type all-solid state secondary battery, it is possible to precipitate the supplied metal ions to form the negative electrode active material layer (to make the all-solid state secondary battery in a charged state).

The charging conditions are not particularly limited; however, examples thereof include the following conditions.
Current: 0.05 to 30 mA/cm²
Voltage: 4.0 to 4.5 V
Charging time: 0.1 to 100 hours
Temperature: 0° C. to 80° C.

It is preferable that the step of charging is carried out by pressurizing and restraining the all-solid state secondary battery (in a discharged state) in the superimposition direction. This makes it possible to suppress the expansion of the all-solid state secondary battery. The restraining pressure in this case is as described above.

—Step of Discharging—

The step of discharging makes it possible to ionize the metal precipitated in the in-battery porous support, thereby being migrated to the positive electrode active material layer.

The discharging conditions are not particularly limited, and examples thereof include the following conditions.
Current: 0.05 to 30 mA/cm²
Voltage: 4.0 to 4.5 V
Charging time: 0.1 to 100 hours
Temperature: 0° C. to 80° C.

It is preferable that the step of discharging is carried out by pressurizing and restraining the all-solid state secondary battery (in a charged state) in the lamination direction. The restraining pressure in this case is as described above and may be the same or different from the restraining pressure in the step of charging.

In this way, each step is carried out and further, the initialization is carried out as appropriate, whereby the all-solid state secondary battery according to the embodiment of the present invention can be manufactured. In this all-solid state secondary battery, the occurrence of the internal short circuit is suppressed, and the cycle characteristics are also excellent as described above. Further, an increase in interface resistance is also suppressed.

### EXAMPLES

Hereinafter, the present invention will be described in more detail with reference to Examples. Meanwhile, the present invention is not interpreted to be limited thereto. “Parts” and “0” that represent compositions in the following Examples are based on the mass unless particularly otherwise described.

### Synthesis Example 1: Synthesis of Sulfide-Based Inorganic Solid Electrolyte Li—P—S-Based Glass

For the sulfide-based inorganic solid electrolyte, an Li—PS-based glass was synthesized with reference to a non-patent document of T. Ohtomo, A. Hayashi, M. Tatsumisago, Y Tsuchida, S. Hama, K. Kawamoto, Journal of Power Sources, 233, (2013), pp. 231 to 235 and A. Hayashi, S. Hama, H. Morimoto, M. Tatsumisago, T. Minami, Chem. Lett., (2001), pp. 872 and 873.

Specifically, in a globe box in an argon atmosphere (dew point: −70° C.), lithium sulfide (Li₂S, manufactured by Sigma-Aldrich Co., LLC Co., LLC Co., LLC, purity: >99.98%) (2.42 g) and diphosphorus pentasulfide (P₂S₅, manufactured by Sigma-Aldrich Co., LLC Co., LLC Co., LLC, purity: >99%) (3.90 g) each were weighed, put into an agate mortar, and mixed using an agate pestle for five minutes. The mixing ratio between Li₂S and P₂S₅(Li₂S:P₂S₅) was set to 75:25 in terms of molar ratio. 66 g of zirconia beads having a diameter of 5 mm were put into a 45 mL container made of zirconia (manufactured by FRITSCH), the entire amount of the mixture of the above lithium sulfide and the diphosphorus pentasulfide was put thereinto, and the container was completely sealed in an argon atmosphere. The container was set in a planetary ball mill P-7 (product name; manufactured by FRITSCH Japan Co., Ltd.), mechanical milling was carried out at a temperature of 25° C. and a rotation speed of 450 rpm for 20 hours. As a result, 6.20 g of a yellow powder of a sulfide-based inorganic solid electrolyte (Li—P—S-based glass; hereinafter, referred to as LPS(1)) was obtained. The average particle diameter according to the above-described measuring method was 10 μm.

### Synthesis Examples 2 and 3: Synthesis of LPS's (2) and (3)

The LPS (1) synthesized in Synthesis Example 1 was used and subjected to wet-type dispersion under the following conditions to adjust the particle diameter, thereby synthesizing LPS's (2) and (3).

That is, 300 zirconia beads having a diameter of 3 mm were put into a 45 mL zirconia container (manufactured by FRITSCH Japan Co., Ltd.), and 4.0 g of the synthesized LPS (1) and 6.0 g of diisobutyl ketone as a dispersion medium were added thereto. Then, this container was set in a planetary ball mill P-7 to carry out wet-type dispersion for 60 minutes under the following condition (1) or (2). As a result, each of LPS's (2) and (3) having the average particle diameter shown below was obtained.
Condition 1: rotation speed of 300 rpm, LPS (2): average particle diameter of 2 μm
Condition 2: rotation speed of 400 rpm, LPS (3): average particle diameter of 1 μm

It is noted that each of the average particle diameters of LPS's (1) to (3) was measured as the volume average particle diameter according to the above-described measuring method, except that a dispersion medium (diisobutyl ketone) was added to the dispersion liquid obtained in each of the above-described synthesis examples to prepare a dispersion liquid for measurement having a concentration of solid contents of 1% by mass.

### Support Production Example 1: Production of Porous Support 1

A porous support 1 was produced using a negative-tone photosensitive polyimide resin as described below.

First, a polyimide precursor was synthesized.

The inside of a flask equipped with a stirrer and a thermometer was replaced with nitrogen gas. Then, 12.86 g of 3,3′-diaminobenzidine and 200 g of N-methyl-2-pyrrolidone were added to the flask. While maintaining the temperature of the mixture in the flask at 10° C. or lower, 18.60 g of isocyanatoethyl methacrylate was further added, followed by stirring at room temperature for 3 hours. Next, 6.00 g of 4,4′-diaminodiphenyl ether and 2.49 g of 1,3-bis(3-aminopropyl)-1,1,3,3,-tetramethyldisiloxane were added to the flask, and then 32.22 g of 3,3′-benzophenonetetracarboxylic acid and 4,4′-benzophenonetetracarboxylic acid dianhydride were further added while carrying out cooling so that the temperature of the reaction solution in the flask did not exceed 40° C. After completion of the addition, the mixture in the flask was stirred at room temperature for 10 hours to obtain a polyimide precursor.

5 parts by mass of a photosensitizing agent and a photopolymerization initiator were added with respect to 100 parts by mass of the synthesized polyimide precursor, and an organic solvent (N-methyl-2-pyrrolidone) was appropriately added until a viscosity that enables coating was obtained, whereby a composition was obtained.

Next, the obtained resin composition was applied onto a smooth glass substrate, which had been subjected to a mold release treatment, by a casting method so that the thickness of the dry film (the film after drying) was 50 μm, and then drying was carried out for 2 hours at a temperature of 180° C. Thereafter, a negative mask having a pattern in which circular pores having a diameter of 5 μm were arranged at an arrangement pitch of 1 μm at a spacing of 1 μm (in each arrangement direction) was closely attached to the surface of the dry film, and ultraviolet irradiation was carried out using a high-pressure mercury lamp so that the accumulated irradiation amount was 3,000 mJ/cm².

After the ultraviolet irradiation, the negative mask was peeled off, development was carried out using an aqueous sodium hydroxide solution, and the dry film was sufficiently dried with hot air at 80° C. for 30 minutes. Then, the dry film was heated at a temperature of 300° C. for 3 hours to accelerate the imidization reaction, thereby obtaining a patterned porous support consisting of the polyimide resin (thickness: 50 μm, void ratio: 70% according to the above-described measuring method).

### Support Production Example 2: Preparation of Porous Support 2

A non-woven fabric (a natural fiber/polyethylene terephthalate (PET)/acrylic resin coating type, manufactured by Asahi Kasei Chemicals Corporation, Silky Fine, WS7R02-14, thickness: 50 μm, void ratio 70% according to the above-described measuring method) was prepared as s porous support 2.

### Support Production Example 3: Preparation of Porous Support 3

A non-woven fabric (a natural fiber/PET/acrylic resin coating type, manufactured by Asahi Kasei Chemicals Corporation, Silky Fine, WS7R02-06, thickness: 30 μm, void ratio 80% according to the above-described measuring method) was prepared as s porous support 3.

### Example 1: Production of Solid Electrolyte Laminated Sheet

### Example 1-1: Production of Solid Electrolyte Laminated Sheet A-1

### Preparation of Solid Electrolyte Composition 1

The LPS (3) having an average particle diameter adjusted to 1 μm and the following binder B-1 were mixed at a mass ratio of 98:2 (in terms of solid content) and put into a 45 mL container made of zirconia (manufactured by FRITSCH), and then 20 g of zirconia beads having a diameter of 3 mm and diisobutyl ketone as a dispersion medium were added thereto adjust the concentration of solid contents to 45% by mass. Thereafter, the container was set in a planetary ball mill P-7, and stirring was carried out at a temperature of 25° C. and a rotation speed of 100 rpm for 1 hour to prepare a solid electrolyte composition 1 (slurry) as a composition for a porous support.
Binder B-1: A copolymer of vinylidene fluoride and hexafluoropropylene (PVdF-HFP, PVdF:HFP=8:2 (mass ratio) (manufactured by Arkema S. A.))

### Preparation of Solid Electrolyte Composition 2

A solid electrolyte composition 2 was prepared as a composition for an in-sheet solid electrolyte layer in the same manner as in the preparation of the solid electrolyte composition 1, except that in the preparation of the solid electrolyte composition 1, the LPS (3) was changed to the LPS (1) having an average particle diameter of 10 μm and the rotation speed during stirring was changed to 50 rpm.

### Production of Solid Electrolyte Laminated Sheet A-1

The porous support 1 was fixed on a polyphenylene sulfide (PPS) film (TORELINA 3000, manufactured by Toray Industries, Inc.), and the solid electrolyte composition 1 was applied onto the porous support 1 under non-heating with a bar coater (SA-201, manufactured by Tester Sangyo Co., Ltd.). In this manner, the solid electrolyte composition 1 was impregnated (invaded) into the inside (the inside of the pores) of the porous support 1, and then heating and drying were carried out at 100° C. for 1 hour to produce an in-sheet porous support.

Next, the solid electrolyte composition 2 was applied onto the surface of the in-sheet porous support with a baker type applicator under non-heating, and then heating and drying were carried out at 100° C. for 1 hour. In this manner, an in-sheet solid electrolyte layer having a thickness of 100 μm was formed on the surface of the in-sheet porous support. The thickness of the in-sheet solid electrolyte layer is the thickness of the layer formed on the surface of the in-sheet solid electrolyte layer.

In this manner, a solid electrolyte laminated sheet A-1 was produced on the PPS film and peeled off from the PPS film to obtain a solid electrolyte laminated sheet A-1.

### Example 1-2: Production of Solid Electrolyte Laminated Sheet A-2

A solid electrolyte composition 3 was prepared as a composition for a porous support in the same manner as in the preparation of the solid electrolyte composition 1, except that in the preparation of the solid electrolyte composition 1, the LPS (3) was changed to the LPS (2) having an average particle diameter adjusted to 2 μm.

Next, a solid electrolyte laminated sheet A-2 was prepared in the same manner as in the production of the solid electrolyte laminated sheet A-1, except that in the production of the solid electrolyte laminated sheet A-1, the solid electrolyte composition 3 was used instead of the solid electrolyte composition 1.

### Example 1-3: Production of Solid Electrolyte Laminated Sheet A-3

A solid electrolyte composition 4 was prepared as a composition for an in-sheet solid electrolyte layer in the same manner as in the preparation of the solid electrolyte composition 2, except that in the preparation of the solid electrolyte composition 2, the LPS (1) having an average particle diameter of 10 μm was changed to the LPS (1) having an average particle diameter of 10 μm and the LPS (3) having an average particle diameter of 1 μm at a mass ratio of 9:1.

Next, a solid electrolyte laminated sheet A-3 was prepared in the same manner as in the production of the solid electrolyte laminated sheet 1, except that in the production of the solid electrolyte laminated sheet 1, the solid electrolyte composition 4 was used instead of the solid electrolyte composition 2.

### Example 1-4: Production of Solid Electrolyte Laminated Sheet A-4

A solid electrolyte composition 5 was prepared as a composition for an in-sheet solid electrolyte layer in the same manner as in the preparation of the solid electrolyte composition 2, except that in the preparation of the solid electrolyte composition 2, the LPS (1) having an average particle diameter of 10 μm was changed to the LPS (1) having an average particle diameter of 10 μm and the LPS (3) having an average particle diameter of 1 μm at a mass ratio of 8:2.

Next, a solid electrolyte laminated sheet A-4 was prepared in the same manner as in the production of the solid electrolyte laminated sheet 1, except that in the production of the solid electrolyte laminated sheet 1, the solid electrolyte composition 5 was used instead of the solid electrolyte composition 2.

### Example 1-5: Production of Solid Electrolyte Laminated Sheet A-5

The porous support 1 was fixed on a stainless steel (SUS) foil having a thickness of 20 μm, and the solid electrolyte composition 1 was applied onto the porous support 1 under non-heating with a bar coater. In this manner, the solid electrolyte composition 1 was impregnated (invaded) into the inside (the inside of the pores) of the porous support 1, and then heating and drying were carried out at 100° C. for 1 hour to produce an in-sheet porous support.

Next, the solid electrolyte composition 4 was applied onto the surface of the in-sheet porous support with a baker type applicator under non-heating, and then heating and drying were carried out at 100° C. for 1 hour. In this manner, an in-sheet solid electrolyte layer having a thickness of 100 μm was formed on the surface of the in-sheet porous support. The thickness of the in-sheet solid electrolyte layer is the thickness of the layer formed on the surface of the in-sheet solid electrolyte layer.

### Example 1-6: Production of Solid Electrolyte Laminated Sheet A-6

A solid electrolyte composition 6 was prepared in the same manner as in the preparation of the solid electrolyte composition 2 as a composition for an in-sheet solid electrolyte layer, except that in the preparation of the solid electrolyte composition 2, the LPS (1) having an average particle diameter of 10 μm was changed to the LPS (1) having an average particle diameter of 10 μm and the LPS (3) having an average particle diameter of 1 μm at a mass ratio of 9:1, and the concentration of solid contents was changed from 45% by mass to 50% by mass.

The porous support 2 was fixed on a stainless steel (SUS) foil having a thickness of 20 μm, and the solid electrolyte composition 1 was applied onto the porous support 2 under non-heating with a bar coater. In this manner, the solid electrolyte composition 1 was impregnated (invaded) into the inside (the inside of the pores) of the porous support 2, and then heating and drying were carried out at 100° C. for 1 hour to produce an in-sheet porous support.

Next, the solid electrolyte composition 6 was applied onto the surface of the in-sheet porous support with a baker type applicator under non-heating, and then heating and drying were carried out at 100° C. for 1 hour. In this manner, an in-sheet solid electrolyte layer having a thickness of 100 μm was formed on the surface of the in-sheet porous support.

### Example 1-7: Production of Solid Electrolyte Laminated Sheet A-7

A solid electrolyte laminated sheet A-7 was prepared in the same manner as in the production of the solid electrolyte laminated sheet A-6, except that in the production of the solid electrolyte laminated sheet A-6, the solid electrolyte composition 3 was used instead of the solid electrolyte composition 1 and the solid electrolyte composition 4 was used instead of the solid electrolyte composition 6.

### Example 1-8: Production of Solid Electrolyte Laminated Sheet A-8

A solid electrolyte laminated sheet A-8 was prepared in the same manner as in the production of the solid electrolyte laminated sheet A-6, except that in the production of the solid electrolyte laminated sheet A-6, the porous support 3 was used instead of the porous support 2.

### Example 1-9: Production of Solid Electrolyte Laminated Sheet A-9

A solid electrolyte composition 7 was prepared as a composition for a porous support in the same manner as in the preparation of the solid electrolyte composition 1, except that in the preparation of the solid electrolyte composition 1, the concentration of solid contents was changed from 45% by mass to 40% by mass.

Next, a solid electrolyte laminated sheet A-9 was prepared in the same manner as in the production of the solid electrolyte laminated sheet A-8, except that in the production of the solid electrolyte laminated sheet A-8, the solid electrolyte composition 7 was used instead of the solid electrolyte composition 1.

### Example 1-10: Production of Solid Electrolyte Laminated Sheet A-10

A solid electrolyte composition 8 was prepared as a composition for a porous support in the same manner as in the preparation of the solid electrolyte composition 1, except that in the preparation of the solid electrolyte composition 1, the concentration of solid contents was changed from 45% by mass to 35% by mass.

Next, a solid electrolyte laminated sheet A-10 was prepared in the same manner as in the production of the solid electrolyte laminated sheet A-8, except that in the production of the solid electrolyte laminated sheet A-8, the solid electrolyte composition 8 was used instead of the solid electrolyte composition 1.

### Comparative Example 1-1: Production of Solid Electrolyte Laminated Sheet B-1

A solid electrolyte composition 9 was prepared as a composition for a porous support in the same manner as in the preparation of the solid electrolyte composition 1, except that in the preparation of the solid electrolyte composition 1, the concentration of solid contents was changed from 45% by mass to 30% by mass.

Next, a solid electrolyte laminated sheet B-1 was prepared in the same manner as in the production of the solid electrolyte laminated sheet A-1, except that in the production of the solid electrolyte laminated sheet A-1, the solid electrolyte composition 9 was used instead of the solid electrolyte composition 1.

### Comparative Example 1-2: Production of Solid Electrolyte Laminated Sheet B-2

A solid electrolyte laminated sheet B-2 was prepared in the same manner as in the production of the solid electrolyte laminated sheet A-3, except that in the production of the solid electrolyte laminated sheet A-3, the solid electrolyte composition 9 was used instead of the solid electrolyte composition 1.

### Comparative Example 1-3: Production of Solid Electrolyte Laminated Sheet B-3

A solid electrolyte laminated sheet B-3 was prepared in the same manner as in the production of the solid electrolyte laminated sheet A-1, except that in the production of the solid electrolyte laminated sheet A-1, the in-sheet solid electrolyte layer was formed using the solid electrolyte composition 2.

### Comparative Example 1-4: Production of Solid Electrolyte Laminated Sheet B-4

A solid electrolyte laminated sheet B-4 was prepared in the same manner as in the production of the solid electrolyte laminated sheet B-1, except that in the production of the solid electrolyte laminated sheet B-1, the in-sheet solid electrolyte layer was formed using the solid electrolyte composition 2.

### Comparative Example 1-5: Production of Solid Electrolyte Laminated Sheet B-5

A solid electrolyte laminated sheet B-5 was prepared in the same manner as in the production of the solid electrolyte laminated sheet A-5, except that in the production of the solid electrolyte laminated sheet A-5, the solid electrolyte composition 1 was changed to the solid electrolyte composition 9.

### Comparative Example 1-6: Production of Solid Electrolyte Laminated Sheet B-6

A solid electrolyte laminated sheet B-6 was prepared in the same manner as in the production of the solid electrolyte laminated sheet A-6, except that in the production of the solid electrolyte laminated sheet A-6, the solid electrolyte composition 1 was changed to the solid electrolyte composition 9.

### Comparative Example 1-7: Production of Solid Electrolyte Laminated Sheet B-7

A solid electrolyte laminated sheet B-7 was prepared in the same manner as in the production of the solid electrolyte laminated sheet A-6, except that in the production of the solid electrolyte laminated sheet A-6, the in-sheet solid electrolyte layer was formed using the solid electrolyte composition 6.

### Comparative Example 1-8: Production of Solid Electrolyte Laminated Sheet B-8

A solid electrolyte laminated sheet B-8 was prepared in the same manner as in the production of the solid electrolyte laminated sheet B-6, except that in the production of the solid electrolyte laminated sheet B-6, the in-sheet solid electrolyte layer was formed using the solid electrolyte composition 6.

<Measurement of Void Ratio and Opening Diameter>

Regarding the produced solid electrolyte laminated sheets A-1 to A-10 and B-1 to B-8, Table 1 shows the void ratios of the porous supports 1 to 3, the in-sheet porous support, and the in-sheet solid electrolyte layer (values measured according to the above-described measuring method), which are used for the production. It is noted that in the measurement of the void ratio, any cross section was taken as the longitudinal cross section (vertical cross section). In addition, Table 1 shows the opening diameters of the porous supports 1 to 3 measured according to the above-described measuring method.

Table 1 shows the thickness of the porous support used, the particle diameter of the inorganic solid electrolyte used, the thickness of the in-sheet solid electrolyte layer used, and further, the filling amount of the inorganic solid electrolyte used into the porous supports 1 to 3 (the difference in void ratio between the porous supports 1 to 3 and the in-sheet porous support). As a result of measuring the particle diameter of the inorganic solid electrolyte in any cross section as a longitudinal cross section (vertical cross section), the particle diameters of the LPS (1) to (3) were substantially the same as the above-described volume average particle diameter. It is noted that since the thickness of the in-sheet porous support in each laminated sheet is the same as the thickness of the porous support used in the production, the description thereof is omitted in Table 1.

In a case where the void ratio or the like cannot be measured or in a case where the in-sheet solid electrolyte layer is not provided, the corresponding column is indicated by a reference numeral “-”.

In Table 1, in a case where the porous support formed on the SUS foil is used, it is shown as “SUS/porous support X” (where X is the porous support number) in the column of “Porous support” in Table 1.

In addition, in a case where a plurality of LPS's are used for forming a film of the in-sheet solid electrolyte layer, “/” is used in the column of “Inorganic solid electrolyte” and the column of “Particle diameter” in Table 1.

Although units of the void ratio, the opening diameter, the filling amount, and the thickness are respectively “%”, “μm”, “%”, and “μm”, these units are omitted in Table 1. “Particle diameter” in Table 1 indicates “the average particle diameter”, where the unit thereof “μm” is omitted.

It is noted that in Table 1, the support (negative electrode collector), the solid electrolyte layer B, and the solid electrolyte layer A of the all-solid state secondary battery manufactured in Reference Example 1 described later are respectively shown in the column of “In-sheet porous support” and the column of “In-sheet solid electrolyte layer”

TABLE 1

| | Solid | In-sheet porous support | | | | | |
|---|---|---|---|---|---|---|---|
| | electrolyte | | | | | Inorganic solid | |
| | laminated | Porous support | | | | electrolyte | |
| | sheet | | Void | | | | Particle |
| | No. | | ratio | Opening | Thickness | | diameter |
| Example 1-1 | A-1 | Support 1 | 70 | 5 | 50 | LPS (3) | 1 |
| Example 1-2 | A-2 | Support 1 | 70 | 5 | 50 | LPS (2) | 2 |
| Example 1-3 | A-3 | Support 1 | 70 | 5 | 50 | LPS (3) | 1 |
| Example 1-4 | A-4 | Support 1 | 70 | 5 | 50 | LPS (3) | 1 |
| Example 1-5 | A-5 | SUS/Support 1 | 70 | 5 | 50 | LPS (3) | 1 |
| Example 1-6 | A-6 | SUS/Support 2 | 70 | 5 | 50 | LPS (3) | 1 |
| Example 1-7 | A-7 | SUS/Support 2 | 70 | 5 | 50 | LPS (2) | 2 |
| Example 1-8 | A-8 | SUS/Support 3 | 80 | 8 | 30 | LPS (3) | 1 |
| Example 1-9 | A-9 | SUS/Support 3 | 80 | 8 | 30 | LPS (3) | 1 |
| Example 1-10 | A-10 | SUS/Support 3 | 80 | 8 | 30 | LPS (3) | 1 |
| Comparative | B-1 | Support 1 | 70 | 5 | 50 | LPS (3) | 1 |
| Example 1-1 | | | | | | | |
| Comparative | B-2 | Support 1 | 70 | 5 | 50 | LPS (3) | 1 |
| Example 1-2 | | | | | | | |
| Comparative | B-3 | Support 1 | 70 | 5 | 50 | LPS (3) | 1 |
| Example 1-3 | | | | | | | |
| Comparative | B-4 | Support 1 | 70 | 5 | 50 | LPS (3) | 1 |
| Example 1-4 | | | | | | | |
| Comparative | B-5 | SUS/Support 1 | 70 | 5 | 50 | LPS (3) | 1 |
| Example 1-5 | | | | | | | |
| Comparative | B-6 | SUS/Support 2 | 70 | 5 | 50 | LPS (3) | 1 |
| Example 1-6 | | | | | | | |
| Comparative | B-7 | SUS/Support 2 | 70 | 5 | 50 | LPS (3) | 1 |
| Exemple 1-7 | | | | | | | |
| Comparative | B-8 | SUS/Support 2 | 70 | 5 | 50 | LPS (3) | 1 |
| Example 1-8 | | | | | | | |
| Reference | | SUS | — | — | — | LPS (3) | 1 |
| Example 1 | | | | | | | |

| | | | In-sheet solid electrolyte layer | | | |
|---|---|---|---|---|---|---|
| | In-sheet porous support | | Inorganic solid electrolyte | | | |
| | Void | Filling | | Particle | Void | |
| | ratio | amount | | diameter | ratio | Thickness |
| Example 1-1 | 60 | 10 | LPS (1) | 10 | 40 | 100 |
| Example 1-2 | 60 | 10 | LPS (1) | 10 | 40 | 100 |
| Example 1-3 | 60 | 10 | LPS (1)/LPS (3) | 10/1 | 30 | 100 |
| Example 1-4 | 60 | 10 | LPS (1)/LPS (3) | 10/1 | 25 | 100 |
| Example 1-5 | 60 | 10 | LPS (1)/LPS (3) | 10/1 | 30 | 100 |
| Example 1-6 | 60 | 10 | LPS (1)/LPS (3) | 10/1 | 30 | 100 |
| Example 1-7 | 60 | 10 | LPS (1)/LPS (3) | 10/1 | 30 | 100 |
| Example 1-8 | 65 | 15 | LPS (1)/LPS (3) | 10/1 | 30 | 100 |
| Example 1-9 | 50 | 30 | LPS (1)/LPS (3) | 10/1 | 30 | 100 |
| Example 1-10 | 40 | 40 | LPS (1)/LPS (3) | 10/1 | 30 | 100 |
| Comparative | 15 | 55 | LPS (1) | 10 | 40 | 100 |
| Example 1-1 | | | | | | |
| Comparative | 15 | 55 | LPS (1)/LPS (3) | 10/1 | 30 | 100 |
| Example 1-2 | | | | | | |
| Comparative | 60 | 10 | — | | | |
| Example 1-3 | | | | | | |
| Comparative | 15 | 55 | — | | | |
| Example 1-4 | | | | | | |
| Comparative | 15 | 55 | LPS (1)/LPS (3) | 10/1 | 30 | 100 |
| Example 1-5 | | | | | | |
| Comparative | 15 | 55 | LPS (1)/LPS (3) | 10/1 | 30 | 100 |
| Example 1-6 | | | | | | |
| Comparative | 60 | 10 | — | | | |
| Exemple 1-7 | | | | | | |
| Comparative | 15 | 55 | — | | | |
| Example 1-8 | | | | | | |
| Reference | — | — | LPS (1) | 10 | — | — |
| Example 1 | | | | | | |

<Note for table>
Supports 1 to 3: The porous supports 1 to 3 prepared or prepared in the above-described support production examples 1 to 3
SUS: Stainless steel foil
LPS (1) to LPS (3): The LPS's synthesized in Synthesis Examples 1 to 3

### Example 2: Manufacture of all-Solid State Secondary Battery

An all-solid state secondary battery was manufactured as follows and its characteristics were evaluated.

In the manufacture of the all-solid state secondary battery, a positive electrode sheet was prepared as follows.

### Production Example 1: Production of Positive Electrode Sheet

### Preparation of Positive Electrode Composition

Lithium nickel manganese cobalt oxide (average particle diameter: 0.5 μm, manufactured by Sigma-Aldrich Co., LLC) as a positive electrode active material, the LPS (2) having an average particle diameter adjusted to 2 μm, acetylene black (average particle diameter: 0.1 μm, manufactured by Denka Company Limited) as a conductive auxiliary agent, and the binder B-1 described below were mixed at a mass ratio of 70:27:2:1 and added to a 45 mL container made of zirconia (manufactured by FRITSCH), and 20 g of zirconia beads having a diameter of 3 mm and diisobutyl ketone as a dispersion solvent were added thereto adjust the concentration of solid contents to 45% by mass. Thereafter, the container was set in a planetary ball mill P-7, and stirring was carried out at a temperature of 25° C. and a rotation speed of 100 rpm for 1 hour to prepare a positive electrode composition (slurry).
B-1: A copolymer of vinylidene fluoride and hexafluoropropylene (PVdF-HFP, PVdF:HFP=8:2 (mass ratio) (manufactured by Arkema S. A.))

—Formation of Positive Electrode Active Material Layer—

The obtained positive electrode composition was applied onto a surface of a carbon-coated aluminum foil (positive electrode collector) having a thickness of 20 μm using a baker type applicator (product name: SA-201), and heating and drying were carried out at 100° C. for 1 hour to produce a positive electrode sheet No. 1 including a positive electrode active material layer (coated and dried layer) having a thickness of 150 μm.

### Examples 2-1 to 2-4: Manufacture of all-Solid State Secondary Batteries 1 to 4

The produced positive electrode sheet was punched out into a disk shape having a diameter of 1 cm to obtain a disk-shaped positive electrode sheet. In addition, the solid electrolyte laminated sheet shown in the column of “Solid electrolyte laminated sheet No.” in Table 2 was punched out into a disk shape having a diameter of 1.2 cm to obtain a disk-shaped solid electrolyte laminated sheet (laminated sheet material). The positive electrode active material layer of the disk-shaped positive electrode sheet and the in-sheet solid electrolyte layer of the disk-shaped solid electrolyte laminated sheet were allowed to face each other to be superimposed so that the disk-shaped positive electrode sheet did not protrude from the disk-shaped solid electrolyte laminated sheet.

In this state, a pressure of 500 MPa was applied for 1 minute in the direction in which the disk-shaped positive electrode sheet and the disk-shaped solid electrolyte laminated sheet were superimposed. By this pressurization, the in-sheet porous support and the in-sheet solid electrolyte layer were pressure-compressed to form an in-battery porous support and an in-battery solid electrolyte layer having the thickness and the void ratio shown in Table 2. In this way, each pressure-bonded laminate of the solid electrolyte laminated sheet and the positive electrode sheet was obtained.

Next, a metallic lithium foil having a thickness of 50 μm was punched out into a disk shape having a diameter of 1.1 cm, disposed on the central part of the surface of the in-sheet porous support of the pressure-bonded laminate (so that the metallic lithium foil punched out into a disk shape did not protruded from the disk-shaped solid electrolyte laminated sheet), and restrained with an SUS rod having a diameter of 1.5 cm from both sides in the lamination direction with a restraining pressure of 5 MPan in the lamination direction.

In this way, each of all-solid state secondary batteries 1 to 4 in an uncharged state was manufactured.

The all-solid state secondary batteries 1 to 4 have a lamination structure shown in FIG. 1, which consists of the negative electrode collector (an SUS rod), the negative electrode active material layer (a metallic lithium foil), the in-battery porous support, the in-battery solid electrolyte layer, the positive electrode active material layer, and the positive electrode collector (an aluminum foil). The thickness of the positive electrode active material layer was 80 μm.

### Examples 2-5 to 2-10: Manufacture of all-Solid State Secondary Batteries 5 to 10

Each pressure-bonded laminate of the solid electrolyte laminated sheet and the positive electrode sheet was obtained in the same manner as in the manufacture of the all-solid state secondary battery 1 of Example 2-1, except that in the manufacture of the all-solid state secondary battery 1 of Example 2-1, the solid electrolyte laminated sheet A-1 was changed to the solid electrolyte laminated sheet shown in the column of “Solid electrolyte laminated sheet No.” in Table 2. In these pressure-bonded laminates, an in-battery porous support and an in-battery solid electrolyte layer having the thickness and the void ratio shown in Table 2 were formed.

Next, each pressure-bonded laminate was restrained with an SUS rod having a diameter of 1.5 cm from both sides in the lamination direction thereof with a restraining pressure of 5 MPan in the lamination direction.

In this way, each of all-solid state secondary batteries 5 to 10 in an uncharged state was manufactured.

The all-solid state secondary batteries 5 to 10 have a lamination structure which consists of the negative electrode collector (an SUS rod and an SUS foil), the in-battery porous support, the in-battery solid electrolyte layer, the positive electrode active material layer, and the positive electrode collector (an aluminum foil). The thickness of the positive electrode active material layer was 80 μm.

### Comparative Examples 2-1 to 2-4: Manufacture of all-Solid State Secondary Batteries C1 to C4

All-solid state secondary batteries C1 to C4 were manufactured in the same manner as in the manufacture of the all-solid state secondary battery 1 of Example 2-1, except that in the manufacture of the all-solid state secondary battery 1 of Example 2-1, the solid electrolyte laminated sheet A-1 was changed to the solid electrolyte laminated sheet shown in the column of “Solid electrolyte laminated sheet No.” in Table 2.

### Comparative Examples 2-5 to 2-8: Manufacture of all-Solid State Secondary Batteries C5 to C8

All-solid state secondary batteries C5 to C8 were manufactured in the same manner as in the manufacture of the all-solid state secondary battery 5 of Example 2-5, except that in the manufacture of the all-solid state secondary battery 5 of Example 2-5, the solid electrolyte laminated sheet A-5 was changed to the solid electrolyte laminated sheet shown in the column of “Solid electrolyte laminated sheet No.” in Table 2.

### Comparative Examples 2-9 and 2-10: Manufacture of all-Solid State Secondary Batteries C9 and C10

All-solid state secondary batteries C9 and C10 were manufactured in the same manner as in the manufacture of the all-solid state secondary battery 1 of Example 2-1, except that in the manufacture of the all-solid state secondary battery 1 of Example 2-1, the pressure when pressurizing the superimposed disk-shaped positive electrode sheet and disk-shaped solid electrolyte laminated sheet was changed from 500 MPa to 300 MPa (Comparative Example 2-9) or 1,000 MPa (Comparative Example 2-10).

The thicknesses of the positive electrode active material layers of the all-solid state secondary batteries C9 and C10 were 85 μm and 75 μm, respectively.

### Reference Example 1: Manufacture of all-Solid State Secondary Battery R

A disk-shaped positive electrode sheet obtained by punching out the positive electrode sheet into a disk shape having a diameter of 1 cm was placed in a cylinder made of polyethylene terephthalate (PET) having a diameter of 10 mm. 30 mg of the LPS (1) having an average particle diameter of 10 μm was placed on the positive electrode active material layer in the cylinder, and an SUS rod having a diameter of 10 mm was inserted from each of both sides of the cylinder. Next, A pressure of 350 MPa was applied from the aluminum foil side and the LPS (1) side of the disk-shaped positive electrode sheet in the axis line direction with an SUS rod to carry out pressurization. In this way, a solid electrolyte layer A consisting of the LPS (1) was formed. The SUS rod on the solid electrolyte layer A side was once removed, 5 mg of the LPS (3) having an average particle diameter adjusted to 1 μm was placed on the solid electrolyte layer A, and a disk-shaped SUS foil having a diameter of 1 cm and punched out into a disk-shape was inserted and disposed thereon. Next, the removed SUS rod was reinserted into the cylinder, a pressure of 10 MPa was applied in the axis line direction, and then the SUS rod was fixed in a state where a pressure of 5 MPa was applied. In this way, a solid electrolyte layer B was formed on the solid electrolyte layer A, and an all-solid state secondary battery R having a two layer structure of the solid electrolyte layers A and B was manufactured.

The all-solid state secondary battery R has a lamination structure which consists of the negative electrode collector (an SUS rod and an SUS foil), the solid electrolyte layer B, the solid electrolyte layer A, the positive electrode active material layer, and the positive electrode collector (an aluminum foil). The thickness of the positive electrode active material layer was 80 μm.

<Measurement of Void Ratio>

Regarding each of the manufactured all-solid state secondary batteries, Table 2 shows the void ratios (measured values according to the above-described measuring method) of the in-battery porous support, the in-battery solid electrolyte layer, and further, the solid electrolyte layers A and B.

In addition, Table 2 shows the thicknesses of the in-battery porous support, the in-battery solid electrolyte layer, and further, the solid electrolyte layers A and B. Although units of the void ratio and the thickness are respectively “%” and “μm”, these units are omitted in Table 2.

<Measurement of Particle Diameter of Particle of Inorganic Solid Electrolyte>

Table 2 shows the results of measuring the particle diameters of the inorganic solid electrolyte internally contained in the in-battery porous support formed by pressurization and the inorganic solid electrolyte constituting the in-battery solid electrolyte layer, according to the above-described measuring method. Although the unit of the particle diameter is “μm”, this unit is omitted in Table 2.

(Initialization)

Each of the manufactured all-solid state secondary batteries was charged to 4.25 V at 0.05 mA/cm² and then discharged to 2.5 V at 0.05 mA/cm² to carry out initialization.

Each of all-solid state secondary batteries 1 to 10, C1 to C10, and R initialized in this way was obtained.

It is noted that in each all-solid state secondary battery, although metallic lithium is precipitated in the voids of the in-battery porous support during charging, the precipitated metallic lithium functions as a negative electrode active material layer in the all-solid state secondary batteries 5 to 10 and C5 to C8.

<Evaluation: Test of Charging and Discharging Cycle Characteristics>

A charging/discharging cycle in which each of the initialized all-solid state secondary batteries is charged to 4.25 V at a current density of 0.5 mA/cm² and then discharged to 2.5 V at 0.5 mA/cm² was set as one cycle, and 100 cycles were repeated.

The discharge capacity retention rate and the presence or absence of occurrence of the internal short circuit in this case were evaluated for the charging and discharging cycle characteristics according to the following standards, and the results are shown in Table 2.

The discharge capacity retention rate was evaluated by determining the rate (in terms of percentage) of the discharge capacity after 100 cycles with respect to the discharge capacity at the first cycle.

In addition, regarding the occurrence of the internal short circuit, it was determined that the internal short circuit had occurred in a case where a sudden voltage drop occurred during charging when the charging and discharging cycles were repeated, the subsequent test of charging and discharging cycle characteristics was stopped, and the evaluation was carried out based on the number of charging and discharging cycles where the internal short circuit occurred.

TABLE 2

| | | | Negative | | | |
|---|---|---|---|---|---|---|
| | All-solid | Solid | electrode | | | |
| | state | electrolyte | active | In-battery porous support | | |
| | secondary | laminated | material | Void | | Particle |
| | battery No. | sheet No. | layer | ratio | Thickness | diameter |
| Example 2-1 | 1 | A-1 | Li foil | 40 | 33 | 1 |
| Example 2-2 | 2 | A-2 | Li foil | 40 | 33 | 2 |
| Example 2-3 | 3 | A-3 | Li foil | 40 | 33 | 1 |
| Example 2-4 | 4 | A-4 | Li foil | 40 | 33 | 1 |
| Example 2-5 | 5 | A-5 | — | 40 | 33 | 1 |
| Example 2-6 | 6 | A-6 | — | 40 | 33 | 1 |
| Example 2-7 | 7 | A-7 | — | 40 | 33 | 2 |
| Example 2-8 | 8 | A-8 | — | 45 | 21 | 1 |
| Example 2-9 | 9 | A-9 | — | 30 | 20 | 1 |
| Example 2-10 | 10 | A-10 | — | 25 | 20 | 1 |
| Comparative | C1 | B-1 | Li foil | 10 | 33 | 1 |
| Example 2-1 | | | | | | |
| Comparative | C2 | B-2 | Li foil | 6 | 20 | 1 |
| Example 2-2 | | | | | | |
| Comparative | C3 | B-3 | Li foil | 40 | 33 | 1 |
| Example 2-3 | | | | | | |
| Comparative | C4 | B-4 | Li foil | 10 | 33 | 1 |
| Example 2-4 | | | | | | |
| Comparative | C5 | B-5 | — | 6 | 20 | 1 |
| Example 2-5 | | | | | | |
| Comparative | C6 | B-6 | — | 6 | 20 | 1 |
| Example 2-6 | | | | | | |
| Comparative | C7 | B-7 | — | 10 | 10 | 1 |
| Example 2-7 | | | | | | |
| Comparative | C8 | B-8 | — | 10 | 33 | 1 |
| Example 2-8 | | | | | | |
| Comparative | C9 | A-1 | Li foil | 50 | 40 | 1 |
| Example 2-9 | | | | | | |
| Comparative | C10 | A-1 | Li foil | 10 | 10 | 1 |
| Example 2-10 | | | | | | |
| Reference | R | — | — | 40 | 40 | 1 |
| Example 1 | | | | | | |

| | | | | Positive | |
|---|---|---|---|---|---|
| | In-battery solid electrolyte layer | | | electrode | |
| | Void | | Particle | active | Test of cycle |
| | ratio | Thickness | diameter | material layer | characteristics |
| Example 2-1 | 10 | 25 | 10 | NMC | 72 |
| Example 2-2 | 10 | 25 | 10 | NMC | 72 |
| Example 2-3 | 6 | 20 | 10/1 | NMC | 72 |
| Example 2-4 | 5 | 20 | 10/1 | NMC | 72 |
| Example 2-5 | 6 | 20 | 10/1 | NMC | 67 |
| Example 2-6 | 6 | 20 | 10/1 | NMC | 63 |
| Example 2-7 | 6 | 20 | 10/1 | NMC | 62 |
| Example 2-8 | 6 | 20 | 10/1 | NMC | 65 |
| Example 2-9 | 6 | 20 | 10/1 | NMC | 61 |
| Example 2-10 | 6 | 20 | 10/1 | NMC | 60 |
| Comparative | 10 | 25 | 10 | NMC | Short circuit |
| Example 2-1 | | | | | in 10 cycles |
| Comparative | 6 | 20 | 10/1 | NMC | Short circuit |
| Example 2-2 | | | | | in 6 cycles |
| Comparative | — | | | NMC | Short circuit |
| Example 2-3 | | | | | in 1 cycle |
| Comparative | — | | | NMC | Short circuit |
| Example 2-4 | | | | | in 2 cycles |
| Comparative | 6 | 20 | 10/1 | NMC | Short circuit |
| Example 2-5 | | | | | in 2 cycles |
| Comparative | 6 | 20 | 10/1 | NMC | Short circuit |
| Example 2-6 | | | | | in 2 cycles |
| Comparative | — | | | NMC | Short circuit |
| Example 2-7 | | | | | in 1 cycle |
| Comparative | — | | | NMC | Short circuit |
| Example 2-8 | | | | | in 1 cycle |
| Comparative | 15 | 37 | 10 | NMC | Short circuit |
| Example 2-9 | | | | | in 20 cycles |
| Comparative | 10 | 25 | 10 | NMC | Short circuit |
| Example 2-10 | | | | | in 10 cycles |
| Reference | 10 | 25 | 10 | NMC | 20 |
| Example 1 | | | | | |

<Note for table>
Li foil: Metallic lithium foil
NMC: Lithium nickel manganese cobalt oxide

The following findings can be seen from the results of Table 1 and Table 2.

The all-solid state secondary batteries C1 and C2 are batteries respectively manufactured by using the solid electrolyte laminated sheets B-1 and B-2 having an in-sheet porous support in which the void ratio is too small. Internal short circuit occurs in these all-solid state secondary batteries in several cycles. This is conceived to be because the void ratio of the in-battery porous support is smaller than the range defined in the present invention, and thus the volume change due to charging and discharging is large, and the in-battery solid electrolyte layer is damaged.

All of the all-solid state secondary batteries C3, C4, C7, and C8 are batteries respectively manufactured by using the solid electrolyte laminated sheets B-3, B-4, B-7, and B-8 having only the in-sheet porous support. Internal short circuit occurs in these all-solid state secondary batteries in only one cycle or two cycles. This is conceived to be because the arrival of dendrites at the positive electrode active material layer cannot be blocked since the in-battery solid electrolyte layer is not provided.

The all-solid state secondary batteries C5 and C6 are self-forming negative electrode type all-solid state secondary batteries respectively manufactured by using the solid electrolyte laminated sheets B-5 and B-6 having an in-sheet porous support in which the void ratio is too small. Therefore, the internal short circuit occurs similarly to the all-solid state secondary batteries C1 and C2; however, in this case, the number of charging and discharging cycles is smaller.

In the all-solid state secondary battery C9, the pressurizing force in the manufacture of the all-solid state secondary battery is too weak even in a case where the solid electrolyte laminated sheet defined in the present invention is used, and the void ratio of the in-battery solid electrolyte layer exceeds 10%, and thus it is not possible to suppress the arrival of dendrites at the positive electrode active material layer, whereby the short circuit occurs in 20 cycles. On the other hand, In the all-solid state secondary battery C10, the pressurizing force in the manufacture of the all-solid state secondary battery is too strong even in a case where the solid electrolyte laminated sheet defined in the present invention is used, and the void ratio of the in-battery porous support is less than 15%, and thus it is not possible to absorb (cancel out) the stress due to volume change, whereby the short circuit occurs.

The reference example is an example in which the cycle characteristics are evaluated regarding the all-solid state secondary battery R which employs a solid electrolyte layer having a two layer structure in which the solid electrolyte layer B having a high void ratio is laminated with the solid electrolyte layer A (corresponding to the in-battery solid electrolyte layer) instead of the in-battery porous support. In this all-solid state secondary battery R, since the solid electrolyte layer B has a void ratio of 40% and the solid electrolyte layer A has a void ratio of 10%, the occurrence of the short circuit can be prevented up to 100 cycles. However, since the porous support is not incorporated in the solid electrolyte layer B, the discharge capacity retention rate is 20%, and thus it cannot be said that the all-solid state secondary battery R is not sufficient as a recent all-solid state secondary battery in which even higher reliability is required.

On the other hand, In any of the all-solid state secondary batteries 1 to 10 according to the embodiment of the present invention, which is manufactured by pressure-bonding and laminating the solid electrolyte laminated sheet defined in the present invention with the positive electrode sheet so that the in-battery porous support and the in-battery solid electrolyte layer satisfy the void ratio defined in the present invention, the occurrence of the internal short circuit can be prevented up to 100 cycles, and moreover, the discharge capacity retention rate after 100 cycles is also as large as 60% or more, whereby excellent cycle characteristics are exhibited.

In particular, the all-solid state secondary batteries 1 to 4 in which the metallic lithium foil is employed as the negative electrode active material layer exhibits very excellent cycle characteristics that the discharge capacity retention rate is 72% after 100 cycles. On the other hand, in the self-forming negative electrode type all-solid state secondary batteries 5 to 10, it is possible to suppress the volume changes and the isolation of metallic lithium even after repeated precipitation and dissolution of metallic lithium, and excellent cycle characteristics are exhibited while the battery capacity is increased.

That is, the all-solid state secondary battery according to the present invention exhibits excellent cycle characteristics while preventing the occurrence of the internal short circuit at a high level and stably operates (drives) even in a case where it is an all-solid state secondary battery of an aspect in which a negative electrode active material layer is formed in advance (in particular, a high-capacity all-solid state secondary battery in which a metallic lithium foil is employed as the negative electrode active material layer), or a self-forming negative electrode type all-solid state secondary battery. Therefore, it is possible to realize a higher level of reliability required for the all-solid state secondary battery in recent years.

The present invention has been described together with the embodiments of the present invention. However, the inventors of the present invention do not intend to limit the present invention in any part of the details of the description unless otherwise designated, and it is conceived that the present invention should be broadly construed without departing from the spirit and scope of the invention shown in the attached “WHAT IS CLAIMED IS”.

### EXPLANATION OF REFERENCES

1: negative electrode collector
2: (in-battery) porous support
3: (in-battery) solid electrolyte layer
4: positive electrode active material layer
5: positive electrode collector
6: operation portion
8: (in-sheet) porous support
9: (in-sheet) solid electrolyte layer
10: all-solid state secondary battery
11: laminated sheet for negative electrode

What is claimed is:

1. A solid electrolyte laminated sheet comprising:
a sheet-shaped porous support which internally contains an inorganic solid electrolyte having ion conductivity of a metal belonging to Group 1 or Group 2 in the periodic table; and
a solid electrolyte layer on one surface of the porous support, which contains an inorganic solid electrolyte having ion conductivity of a metal belonging to Group 1 or Group 2 in the periodic table,
wherein a void ratio of the porous support is 20% or more, and a void ratio of the solid electrolyte layer is smaller than the void ratio of the porous support.

2. The solid electrolyte laminated sheet according to claim 1,
wherein the inorganic solid electrolyte which is internally contained in the porous support is particles smaller than an opening diameter of the porous support.

3. The solid electrolyte laminated sheet according to claim 1,
wherein the inorganic solid electrolyte which is contained in the solid electrolyte layer contains particles larger than and particles smaller than an opening diameter of the porous support.

4. The solid electrolyte laminated sheet according to claim 1, further comprising:
a negative electrode collector on the other surface of the porous support.

5. An all-solid state secondary battery formed of the solid electrolyte laminated sheet according to claim 1,
wherein the all-solid state secondary battery has a layer structure in which a negative electrode collector, the porous support of the solid electrolyte laminated sheet, the solid electrolyte layer, and the positive electrode active material layer are laminated and pressure-bonded in this order,
a void ratio of the porous support after the lamination and the pressure bonding is 15% or more, and
a void ratio of the solid electrolyte layer after the lamination and the pressure bonding is 10% or less.

6. The all-solid state secondary battery according to claim 5,
wherein the all-solid state secondary battery has a negative electrode active material layer between the negative electrode collector and the porous support.

7. The all-solid state secondary battery according to claim 6,
wherein the negative electrode active material layer is a metallic lithium foil.

8. The all-solid state secondary battery according to claim 5,
wherein in a charged state of the all-solid state secondary battery, at least the porous support internally contains a negative electrode active material.

9. The all-solid state secondary battery according to claim 5,
wherein the inorganic solid electrolyte which is internally contained in the porous support after the lamination and the pressure bonding is particles smaller than an opening diameter of the porous support.

10. The all-solid state secondary battery according to claim 5,
wherein the inorganic solid electrolyte which is contained in the solid electrolyte layer after the lamination and the pressure bonding contains particles larger than and particles smaller than an opening diameter of the porous support.

11. A manufacturing method for an all-solid state secondary battery, which is a manufacturing method for an all-solid state secondary battery by using the solid electrolyte laminated sheet according to claim 1, the manufacturing method comprising:
a step of pressurizing the solid electrolyte laminated sheet until the solid electrolyte layer has a void ratio of 10% or less while suppressing a void ratio of the porous support of the solid electrolyte laminated sheet to 15% or more.

12. The manufacturing method for an all-solid state secondary battery according to claim 11, further comprising:
a step of forming a negative electrode active material layer between the negative electrode collector and the porous support.

13. The manufacturing method for an all-solid state secondary battery according to claim 12,
wherein the step of forming the negative electrode active material layer is a step of forming a film of a negative electrode composition containing a negative electrode active material or a step of laminating a metallic lithium foil.

14. The manufacturing method for an all-solid state secondary battery according to claim 12,
wherein the step of forming the negative electrode active material layer is a step of charging an all-solid state secondary battery to precipitate a negative electrode active material at least in the porous support, after the step of the pressurizing.
